(19) United States
(12) Patent Application Publication
(10) Pub. No.: US 2026/0004401 A1
(43) Pub. Date: Jan. 1, 2026

(54) High Throughput High Dynamic Range (HDR) Microscopy

(71) Applicant: Wolfspeed, Inc., Durham, NC (US)

(72) Inventors: Matthew David Conrad, Cary, NC (US); Jason William Leon Witry, Bahama, NC (US); Edward Robert Van Brunt, Cary, NC (US)

(21) Appl. No.: 18/759,385

(22) Filed: Jun. 28, 2024

(51) Int. Cl. G06T 5/50; G01N 21/64; G01N 21/95; G06T 3/02; G06T 3/40; G06T 7/00

(52) U.S. Cl. CPC G06T 5/50; G01N 21/6456; G01N 21/6489; G01N 21/9501; G06T 3/02; G06T 3/40; G06T 7/0008; G06T 2207/20208; G06T 2207/20221; G06T 2207/30164

(57) ABSTRACT

An example method includes obtaining a plurality of images of at least a portion of a semiconductor workpiece. Each of the plurality of images associated with exposing the at least a portion of the semiconductor workpiece to radiation at a different radiation intensity. The example method includes generating a composite workpiece image of at least a portion of the semiconductor workpiece based at least in part on the plurality of images.

### FIELD

The present disclosure relates generally to manufacturing semiconductor devices.

### BACKGROUND

Power semiconductor devices are used to carry large currents and support high voltages. A wide variety of power semiconductor devices are known in the art including, for example, transistors, diodes, thyristors, power modules, discrete power semiconductor packages, and other devices. For instance, example semiconductor devices may be transistor devices such as Metal Oxide Semiconductor Field Effect Transistors (“MOSFET”), bipolar junction transistors (“BJTs”), Insulated Gate Bipolar Transistors (“IGBT”), Gate Turn-Off Transistors (“GTO”), junction field effect transistors (“JFET”), high electron mobility transistors (“HEMT”) and other devices. Example semiconductor devices may be diodes, such as Schottky diodes or other devices.

Power semiconductor devices may be packaged into various semiconductor device packages, such as discrete semiconductor device packages and power modules. Power modules may include one or more power devices and other circuit components and can be used, for instance, to dynamically switch large amounts of power through various components, such as motors, inverters, generators, and the like.

Semiconductor devices may be fabricated from workpieces of semiconductor material, such as silicon, sapphire, silicon carbide (SiC), Group III nitride-based semiconductor materials, and/or the like. These materials exhibit many attractive electrical and thermophysical properties, making it suitable for the fabrication of workpieces or substrates for high power density solid state devices, such as power electronic, radio frequency, and optoelectronic devices. During manufacturing, these materials may have crystalline material features at multiple length scales, from workpiece-sized features down to micron-scale features or sub-micron scale features (e.g., nanometer scale features). It may be desirable to detect and characterize the features during device manufacturing.

### SUMMARY

Aspects and advantages of embodiments of the present disclosure will be set forth in part in the following description, or can be learned from the description, or can be learned through practice of the embodiments.

In an aspect, the present disclosure provides an example method. In some implementations, the example method includes obtaining a plurality of images of at least a portion of a semiconductor workpiece, each of the plurality of images associated with exposing the at least a portion of the semiconductor workpiece to radiation at a different radiation intensity. In some implementations, the example method includes generating a composite workpiece image of at least a portion of the semiconductor workpiece based at least in part on the plurality of images.

In an aspect, the present disclosure provides an example semiconductor workpiece inspection system. In some implementations, the example semiconductor workpiece inspection system includes an imaging device. In some implementations, the example semiconductor workpiece inspection system includes a radiation source. In some implementations, the example semiconductor workpiece inspection system includes a workpiece holder operable to receive a semiconductor workpiece. In some implementations, the example semiconductor workpiece inspection system includes control circuitry operable to perform operations. In some implementations, the operations include obtaining a plurality of images of at least a portion of a semiconductor workpiece, each of the plurality of images associated with exposing the at least a portion of the semiconductor workpiece to radiation at a different radiation intensity. In some implementations, the operations include generating a composite workpiece image of at least a portion of the semiconductor workpiece based at least in part on the plurality of images.

In an aspect, the present disclosure provides an example method. In some implementations, the example method includes obtaining one or more images of at least a portion of a semiconductor workpiece. In some implementations, the example method includes obtaining a response function correlating an intensity of a radiation source with pixel values, wherein the response function is determined based at least in part on a plurality of sample images associated with exposing at least a portion of one or more semiconductor workpieces with different radiation intensities. In some implementations, the example method includes generating transformed image data based at least in part on the response function.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example semiconductor workpiece inspection system according to example embodiments of the present disclosure;

FIG. 2 depicts an example semiconductor workpiece inspection system according to example embodiments of the present disclosure;

FIG. 3 depicts an example semiconductor workpiece inspection system according to example embodiments of the present disclosure;

FIG. 4 depicts a top perspective view of an example workpiece holder according to example embodiments of the present disclosure;

FIG. 5 depicts a close-up plan view of the example workpiece holder of FIG. 4 according to example embodiments of the present disclosure;

FIG. 6 depicts a portion of an example fiducial structure according to example embodiments of the present disclosure;

FIG. 7 depicts example images of a semiconductor workpiece according to example embodiments of the present disclosure;

FIGS. 8A-8B depict an illustrative example of spatially correlating images of a semiconductor workpiece according to example embodiments of the present disclosure;

FIG. 9 depicts correlated plots of an example response function associated with an example semiconductor workpiece imaging system according to example embodiments of the present disclosure;

FIG. 10 depicts example composite workpiece images of a semiconductor workpiece according to example embodiments of the present disclosure;

FIG. 11 depicts an illustrative example of generating a composite workpiece image of a semiconductor workpiece according to example embodiments of the present disclosure; and

FIG. 12 depicts a flow chart diagram of an example method according to example embodiments of the present disclosure.

FIG. 13 depicts a flow chart diagram of an example method according to example embodiments of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

Semiconductor device packages (e.g., discrete semiconductor device packages and power modules) have been developed that include a semiconductor die, such as a metal-oxide-semiconductor field-effect transistor (MOSFET), a Schottky diode, and/or a high electron mobility transistor (HEMT) device. Semiconductor device packages with MOSFETs may be employed in a variety of applications to enable higher switching frequencies along with reduced associated losses, higher blocking voltages, and improved avalanche capabilities. Example applications may include high performance industrial power supplies, server/telecom power, electric vehicle charging systems, energy storage systems, uninterruptible power supplies, high-voltage DC/DC converters, electric vehicles, and battery management systems. Semiconductor device packages with Schottky diodes and/or HEMT devices may be employed in many of the same high-performance power applications described above for MOSFETs, sometimes in systems that also include discrete power packages of MOSFETs.

Power semiconductor device packages may include one or more semiconductor die having at least one semiconductor structure, such as a power semiconductor device. In some examples, power semiconductor devices may include a wide bandgap semiconductor material, such as silicon carbide (SiC) semiconductor materials and/or Group III nitride-based (e.g., gallium nitride (GaN)) semiconductor materials. For instance, in some examples, the one or more semiconductor die may include, e.g., wide bandgap semiconductor devices, silicon carbide-based semiconductor devices (e.g., MOSFETs, Schottky diodes), Group III nitride-based semiconductor devices (e.g., HEMT devices), and the like.

As used herein, a “wide bandgap semiconductor material” refers to a semiconductor material having a band gap greater than about 1.40 eV. Aspects of the present disclosure are discussed herein with reference to silicon carbide-based semiconductor structures/layers as wide bandgap semiconductor structures/layers for purposes of illustration and discussion. Those having ordinary skill in the art, using the disclosures provided herein, will understand that any suitable semiconductor material, such as other wide bandgap semiconductor materials, may be used without deviating from the scope of the present disclosure. By way of non-limiting example, example wide bandgap semiconductor materials include silicon carbide and/or Group III-nitrides.

Semiconductor devices may be fabricated by performing fabrication processes on a semiconductor workpiece. A semiconductor workpiece may be a semiconductor wafer, which is a thin, disc-shaped sheet of semiconductor material (e.g., silicon (Si), SiC, GaN, etc.) that may serve as the foundation for manufacturing semiconductor devices, such as integrated circuits (ICs) and/or other electronic components. In some examples, a power semiconductor device (e.g., MOSFET, JFETs, Schottky diode, HEMT device, etc.) may be fabricated on a silicon carbide-based semiconductor workpiece, which may serve as a substrate for the power semiconductor device.

As used herein, a “substrate” and a “wafer” both refer to a crystalline material, such as a single crystal semiconductor material. In certain embodiments, a substrate may have sufficient thickness (i) to be surface processed (e.g., lapped and/or polished) to support epitaxial deposition of one or more semiconductor material layers, and optionally (ii) to be free-standing. In certain embodiments, a substrate may have a generally cylindrical or circular shape, and/or may have a thickness of at least about one or more of the following thicknesses: 200 microns (μm), 300 μm, 350 μm, 750 μm, 1 millimeter (mm), 2 mm, 3 mm, 5 mm, 1 centimeter (cm), 2 cm, 5 cm, 10 cm, 20 cm, 30 cm, or more.

In certain embodiments, a wafer may comprise a diameter of approximately 100 mm or greater, or approximately 150 mm or greater, or approximately 200 mm or greater, or approximately 300 mm or greater, or approximately 450 mm or greater, or in a range including approximately 100 mm to approximately 450 mm, or in a range including approximately 150 mm to approximately 450 mm, or in a range including approximately 150 mm to approximately 300 mm, or in a range including approximately 100 mm to approximately 200 mm.

Aspects of the present disclosure are discussed with reference to a workpiece that is a semiconductor wafer that includes silicon carbide (SiC) (e.g., a “silicon carbide semiconductor wafer”) for purposes of illustration and discussion. Those having ordinary skill in the art, using the disclosures provided herein, will understand that aspects of the present disclosure can be used with other semiconductor workpieces. Other workpieces may include carrier substrates, ingots, boules, polycrystalline substrates, monocrystalline substrates, bulk crystalline material having a thickness of greater than about 1 millimeter, such as greater than about 5 millimeters, such as greater than about 10 millimeters, such as greater than about 20 millimeters, such as greater than about 50 millimeters, such as greater than about 100 millimeters, to 200 millimeters, etc.

In some examples, the semiconductor workpiece includes silicon carbide (SiC) crystalline material. The silicon carbide crystalline material may have a 4H crystal structure, 6H crystal structure, or other crystal structure. The semiconductor workpiece may be an on-axis workpiece (e.g., end face parallel to the (0001) plane) or an off-axis workpiece (e.g., end face non-parallel to the (0001) plane), such as a 2°, 4°, 6°, or 8° off-axis workpiece.

Crystalline materials (e.g., silicon carbide (SiC) crystalline materials, etc.) may be produced in crystal growth systems using various seeded sublimation crystal growth processes. More particularly, in some crystal growth processes, a seed material and source material are arranged in a reaction crucible which is then heated to the sublimation temperature of the source material. By controlled heating of the environment surrounding the reaction crucible, a thermal gradient is developed between the sublimating source material and the marginally cooler seed material. Based on the resulting thermal gradient, source material in a vapor phase is transported onto the seed material where it condenses to grow a bulk crystalline boule. This type of crystal growth process is commonly referred to as a physical vapor transport (PVT) process. In some examples, the resulting crystalline boule may then be diced (e.g., cut) into semiconductor wafers (e.g., semiconductor workpieces), which may then be used as seed material for a seeded sublimation growth process and/or as substrates upon which a variety of semiconductor devices (e.g., power semiconductor devices, discrete semiconductor packages, power modules, etc.) may be formed.

Those having ordinary skill in the art, using the disclosures provided herein, will appreciate that semiconductor workpieces of the present disclosure may be fabricated using any suitable fabrication process without deviating from the scope of the present disclosure.

Methods for forming semiconductor wafers from boules may include, for instance, cutting thin layers (e.g., wafers) from the boule using wire saws. Another example removal process for forming semiconductor wafers from boules may include a laser-based removal process. Laser-based removal processes may include providing subsurface laser damage patterns to a boule to form weakened areas in the boule. Portions may then be separated from the boule along the weakened areas to produce semiconductor wafers. Separation processes may include, for example, ultrasonic fracturing, mechanical force fracturing, or other fracturing methods.

The separating (e.g., fracturing) process may produce a rough and uneven surface on both the boule and the crystalline material substrates separated from the boule. For instance, in a laser-based removal process, laser strength, depth, weakened area proximity to other weakened areas, and laser power may contribute to the formation of residual cracks and defects protruding outward from the weakened areas which, in turn, create the rough surface of the boule and the semiconductor wafers removed from the boules.

Semiconductor devices and device manufacturing may require smooth surfaces on a semiconductor workpiece. Accordingly, in some cases, before continuing with further separations of the boule or further manufacturing with the semiconductor workpiece, rough surface(s) may need to be subjected to surface processing operations. Methods for surface processing of boules and substates (e.g., semiconductor wafers) in semiconductor manufacturing may include grinding, lapping, and/or polishing the rough surfaces until sufficient smoothness is achieved.

Grinding is a material removal process that is used to remove material from the semiconductor workpiece. Grinding may be used to reduce a thickness of the semiconductor workpiece. Grinding typically involves exposing the semiconductor workpiece to an abrasive-containing surface, such as grind teeth on a grind wheel. Grinding may remove material of the semiconductor workpiece through engagement with the abrasive surface.

Lapping is a precision finishing process that uses a loose abrasive in slurry form. The slurry typically includes coarser particles (e.g., largest dimension of the particles being greater than about 100 microns) to remove material from the semiconductor workpiece. Lapping typically does not include engaging the semiconductor workpiece with an abrasive-containing surface on the lapping tool (e.g., a wheel or disc having an abrasive-containing surface). Rather, the semiconductor workpiece typically comes into contact with a lapping plate or a tile that is usually made of metal. Lapping typically provides better planarization of the semiconductor workpiece relative to grinding.

Polishing is a process to remove imperfections from the semiconductor workpiece to create a very smooth surface with low surface roughness. Polishing may be performed using a slurry and a polishing pad. The slurry typically includes finer particles relative to lapping, but coarser particles relative to chemical mechanical planarization (CMP). Polishing typically provides better planarization of the semiconductor workpiece relative to grinding.

Chemical mechanical planarization (CMP) is a type of fine or ultrafine polishing, typically used to produce a smoother surface ready, for instance, for epitaxial growth of layers on the semiconductor workpiece. CMP may be performed chemically and/or mechanically to remove imperfections and to create a very smooth and flat surface with low surface roughness. CMP typically involves changing the material of the semiconductor workpiece through a chemical process (e.g., oxidation) and removing the new material from the semiconductor workpiece through abrasive contact with a slurry and/or other abrasive surface or polishing pad (e.g., oxide removal). In CMP, the abrasive elements in the slurry typically remove the product of the chemical process and do not remove the bulk material of the semiconductor workpiece, often leaving very low subsurface damage.

Electrochemical Mechanical Polishing (ECMP) is a specialized process used in semiconductor manufacturing for polishing and planarizing surfaces with high precision. ECMP combines the principles of electrochemical and mechanical actions to achieve highly uniform material removal rates across the surface of a semiconductor workpiece. For example, a silicon carbide semiconductor workpiece may be mounted or provided on a workpiece carrier, which brings the wafer into contact with a polishing pad. A slurry (including an electrolyte solution) may be applied between the semiconductor workpiece and the polishing pad to facilitate the electrochemical reactions, carry away removed material, and provide lubrication for the mechanical polishing action. A bias (e.g., bias voltage and/or bias current) may be applied between the semiconductor workpiece and the electrolyte solution of the slurry to drive electrochemical reactions to occur at the surface of the semiconductor workpiece, leading to material dissolution. The electrochemical reactions may vary depending on the specific materials involved, but they often involve oxidation or reduction processes.

Crystalline semiconductor workpieces may include various structural crystal defects or extended defects, including dislocations (e.g., threading, edge, threading edge, basal plane, threading screw, screw, and/or super screw dislocations or micropipes, among others), hexagonal voids, stacking faults, and/or the like. Such defects may be formed during crystal growth and/or during heat-up or cooldown after growth, where one or more discontinuities are formed in the material lattice structure of the crystalline semiconductor workpiece. The aforementioned defects may be detrimental to fabrication, proper operation, device yield, reliability of the one or more semiconductor devices subsequently formed on the crystalline semiconductor workpieces, and/or the like. Because crystalline material defects may range from workpiece-size defects to micron and/or sub-micron defects (e.g., nanometer scale), identifying and characterizing these defects may be challenging, particularly at scale.

Certain metrology and/orinspection solutions may be able to detect crystalline defects and features, such as individual micropipes, basal plane dislocation, scratches, etc., using high resolution semiconductor workpiece imaging (e.g., about 1 to about 10 microns per pixel). More particularly, some semiconductor manufacturing processes may implement scanning processes, whereby a plurality of images of the semiconductor workpiece are obtained using, for instance, a line-scan camera. In such examples, each of the plurality of images may be hundreds of millimeters long but may only be a few millimeters wide. By “stitching” and/or otherwise combining each of the plurality of images, a single image of the entire semiconductor workpiece may be generated, and one or more workpiece characteristics and/or defects of the semiconductor workpiece may be determined based at least in part on the single image of the semiconductor workpiece. Moreover, to further improve the accuracy of defect detection, some semiconductor manufacturing processes may obtain the plurality of images in a plurality of different image modalities (e.g., birefringent contrast modality (cross-polarized light modality), photoluminescence modality, x-ray modality, scanning electron microscopy modalities, etc.). It should be noted that the terms “birefringent contrast imaging” and “cross-polarized light imaging” may be used interchangeably.

As an illustrative example, some scanning processes may include obtaining a plurality of images of the semiconductor workpiece in an image modality, such as a cross-polarized light image modality. More particularly, the semiconductor workpiece may be illuminated by a radiation source that emits radiation signals at a particular radiation intensity. The radiation signals are received by a detector, and the plurality of images are generated based on the received radiation signals. Subsequently, the imaging system “stiches” or otherwise combines the plurality of images into a composite image of the semiconductor workpiece, which includes data of the entire semiconductor workpiece in the image modality (e.g., cross-polarized light image modality). Based on the composite image of the semiconductor workpiece, one or more workpiece characteristics and/or defects associated with the semiconductor workpiece may be determined.

However, a variety of factors related to the imaging systems and/or the imaging conditions associated with the plurality of images may introduce inaccuracies to the composite image of the semiconductor workpiece and, hence, to the workpiece characterizations and defect detections that are based at least in part on the composite image. For instance, system-level factors (e.g., movement of the imaging device(s) and/or the workpiece, etc.) may introduce a variety of alignment issues when “stitching” or otherwise combining the plurality of images into the composite image of the semiconductor workpiece, such as stitching misalignments, stitching offsets, spatial correlation defects, and/or the like. Additionally, the radiation signals received at the detector may be impacted by the workpiece features and/or defects associated with the semiconductor workpiece, such as surface roughness, resistivity, thickness, and/or the like. For instance, the radiation signals may have a variation that spans many orders of magnitude depending on the type and severity of the characteristic and/or defect associated with the semiconductor workpiece. Moreover, some workpiece features and/or defects may be undetectable absent long exposure from the light source, while others may be detectable with a short exposure from the light source. As such, in addition to the “stitching”-related inaccuracies discussed above, typical scanning processes are also prone to inaccuracies stemming from the imaging conditions (e.g., single exposure, single intensity) associated with the plurality of images.

For instance, the overall accuracy of workpiece characteristic and/or defect detection associated with such inspection processes are often limited by a number of hardware-related factors associated with the imaging system itself. For instance, imaging systems include one or more imaging devices operable to obtain a plurality of images. However, imaging devices include a number of sensors that affect the overall quality of the images captured therewith, such as an imaging sensor. As will be discussed in greater detail below, imaging sensors include dozens, hundreds, thousands and/or millions (or more) radiation-sensitive receptors (e.g., pixels) that are operable to capture light or radiation.

As used herein, the term “light” is not restricted to visible light. The term “light” may refer to any electromagnetic radiation, including electromagnetic radiation that is responsive to optical elements, such as reflectors, refractors, and/or diffractors, such as infrared radiation, ultraviolet radiation, visible light (e.g., wavelength of about 380 nm to about 700 nm), or other electromagnetic radiation. The term “radiation” may be used synonymously with “light” herein. Furthermore, as used herein, the use of the term “optical” in conjunction with an element, path, or other term does not restrict the element, path, or other term to visible light, but may be associated with any electromagnetic radiation, such as visible light, infrared radiation, ultraviolet radiation, and/or the like. Even further, as used herein, a “channel” may refer to system of components operable to obtain images of a certain image modality. A “channel” may include the radiation source, the detector, and the optical path between the radiation source and the detector. The “channel” may include one or more optical elements (e.g., reflectors, refractors, splitters, diffractors, attenuators, amplifiers, sensors, etc.) in the optical path between the radiation source and the target.

Imaging devices capture light through an array of pixels, each of which having an associated “pixel value”. One important photometric associated with imaging systems and imaging devices (e.g., associated with the corresponding image sensor) is dynamic range, which corresponds to a range and/or ratio of light intensities (e.g., brightness, luminance, etc.) an imaging device is operable to capture. More particularly, as used herein, “dynamic range” refers to the range and/or ratio between a maximum measurable brightness (e.g., luminance) to the lowest detectable brightness (e.g., luminance) of an imaging device.

Dynamic range is often used to describe a luminance range (or the limits thereof) of an imaging device and/or of images captured therewith. Put differently, “dynamic range” is one photometric that determines how much detail is captured by an image and/or an imaging device, because it is a measure of the pixel value variation between the brightest areas (e.g., maximum pixel value) and the darkest areas (e.g., minimum pixel value). As an illustrative example, imaging systems and imaging devices having a low dynamic range capture images with a narrower range of light intensities, which results in captured images having less vibrant colors, lower contrasts, and less detail in extreme lighting conditions (e.g., in shadows, in bright areas, etc.). Hence, the dynamic range associated with the one or more imaging devices of semiconductor workpiece imaging systems may affect the resulting accuracy of workpiece characterization and/or defect detection processes associated with such semiconductor workpiece imaging systems.

Accordingly, example aspects of the present disclosure are directed to semiconductor workpiece imaging systems and methods operable to obtain a plurality of images of a semiconductor workpiece by exposing at least a portion of the semiconductor workpiece at different radiation intensities and generating a composite workpiece image of the semiconductor workpiece based at least in part on the plurality of images.

As used herein, an “image” is any two-dimensional representation of data. Data that is spatially coordinated (e.g., to an x and y position of a workpiece) may be referred to as an image. A “composite image” may be an image that combines data from two or more sources. Generating a composite workpiece image does not require actual rendering of data in a visual form, but rather generating and/or storing image data based on multiple sources of data. Furthermore, “images” may be categorized and/or distinguished based on a corresponding “image modality” which, as used herein, refers to a method, technique, and/or principle used to obtain the “image.” By way of non-limiting example, a “birefringent contrast image” refers to an image captured in a birefringent contrast image modality. Likewise, a “photoluminescence image” refers to an image captured in a photoluminescence image modality. Although generally discussed with reference to birefringent contrast images and photoluminescence images, those having ordinary skill in the art, using the disclosures provided herein, will understand that example aspects of the present disclosure may be applied to any suitable image in any suitable image modality without deviating from the scope of the present disclosure, such as reflection based image modalities.

As will discussed in greater detail below, to improve the accuracy and detail of workpiece characterization and/or defect detection processes and to address the system- and hardware-related issues described above, composite workpiece images generated by the semiconductor workpiece imaging systems of the present disclosure have a greater dynamic range than the individual images of the plurality of images. As such, composite workpiece images of the present disclosure may include data associated with workpiece characteristics and/or defects associated with the semiconductor workpiece across a wide range of radiation intensities.

More particularly, as discussed in greater detail below, an example semiconductor workpiece imaging system of the present disclosure may include an imaging device operable to capture a plurality of images in a plurality of different image modalities. The semiconductor workpiece imaging system may further include a workpiece holder having a receptable operable to receive a semiconductor workpiece, such as a semiconductor workpiece having a hexagonal crystal structure. The semiconductor workpiece imaging system may further include a radiation source. The radiation source may be operable to expose at least a portion of the semiconductor workpiece to different radiation intensities. For instance, the radiation source may have a non-uniform radiation distribution that exposes at least a portion of the semiconductor workpiece to different radiation intensities as the radiation source scans the workpiece. Alternatively, the intensity of the radiation provided by the radiation source is adjusted (e.g., increased or decreased) as the radiation source scans the workpiece. To identify and characterize one or more features, characteristics, and/or defects associated with the semiconductor workpiece, a plurality of images of at least a portion of the semiconductor workpiece may be obtained, and a composite workpiece image of the semiconductor workpiece may be generated based at least in part on the plurality of images.

In some examples, the semiconductor workpiece imaging system may include control circuitry (e.g., processor(s).) operable to perform high dynamic range (HDR) imaging and, hence, generate composite workpiece images having an increased dynamic range. As used herein, “high dynamic range (HDR)” imaging refers to an image processing process whereby one of more images are obtained and spatially correlated and/or otherwise combined to generate a composite image (e.g., composite workpiece image) that includes greater dynamic range than the corresponding individual images. Hence, in some examples, the composite workpiece image may be a high-dynamic range (HDR) image of the semiconductor workpiece.

More particularly, each of a plurality of measurement areas of the semiconductor workpiece may be illuminated by the radiation source for a plurality of illumination instances. Each illumination instance may be associated with one of a plurality of different radiation intensities. The plurality of images may then be spatially correlated to generate a composite image segment for each measurement area, and the composite workpiece image may be generated based at least in part on the composite image segment for each of the plurality of measurement areas. It should be understood that, as used herein, “spatial correlation” refers to a relationship and/or similarity between one or more pixels in each of the plurality of images, the spatial coordinates of each of the plurality of images, and/or the like, and “spatially correlating” refers to aligning, combining, and/or otherwise correlating each of the plurality of images based at least in part on the relationship and/or similarity between the one or more pixels, the spatial coordinates, and/or the like.

As will be discussed in greater detail below, one or more workpiece characteristics of the semiconductor workpiece may be determined based at least in part on the composite workpiece image. For instance, in some examples, one or more defects associated with the semiconductor workpiece may be determined based at least in part on the composite workpiece image, such as a presence of one or more micropipes on the semiconductor workpiece, one or more threading edge dislocations on the semiconductor workpiece, one or more threading screw dislocations on the semiconductor workpiece, and/or the like. Additionally and/or alternatively, in some examples, one or more surface features of the semiconductor workpiece may be determined based at least in part on the composite workpiece image, such as a surface roughness of the semiconductor workpiece, a parallelism of the semiconductor workpiece, an optical wedge of the semiconductor workpiece, and/or the like.

It should be noted that, although described herein with reference to semiconductor workpiece inspection systems, aspects of the present disclosure may be implemented in any suitable imaging system. Those having ordinary skill in the art, using the disclosures provided herein, will understand that the systems and methods described herein are not limited to spatially correlating, aligning, and/or combining images of workpieces obtained by workpiece imaging systems and may be applicable to spatially correlating, aligning, and/or combining any suitable image obtained by any suitable imaging system.

Aspects of the present disclosure provide a number of technical effects and benefits, including improvements to computing technology and/or semiconductor fabrication technology. For instance, example aspects of the present disclosure allow for the spatial correlation and/or alignment of multiple imaging devices separated by arbitrary distances and in arbitrary geometries. As such, imaging system performance may be improved, while costs associated with the imaging systems may be decreased. Moreover, by scanning a workpiece with multiple passes at varying radiation intensities (or with a radiation source having a non-uniform radiation distribution), a composite workpiece image having a high dynamic range may be generated, thereby increasing the image quality of the composite workpiece image relative to a workpiece image taken at a single radiation intensity. More particularly, illuminating the semiconductor workpiece at low radiation intensities allows for high-quality contrast on strong workpiece characteristics, while illuminating the semiconductor workpiece at high radiation intensities allows for high-quality contrast on weak workpiece characteristics. As such, by generating a composite workpiece image of the semiconductor workpiece that includes data associated with each radiation intensity, workpiece characteristics having a wide range of magnitudes may be detected in a non-destructive manner. Thus, example aspects of the present disclosure provide a workpiece characterization and defect detection process with greater sensitivity to characteristics and/or defects important to the fabrication process. In this manner, the present disclosure provides for easy data collection and enhanced detail and accuracy in composite workpiece images.

It will be understood that, although the terms first, second, third, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

It will be understood that when an element such as a layer, region, or substrate is referred to as being “on” or extending “onto” another element, it may be directly on or extend directly onto the other element or intervening elements may also be present. In contrast, when an element is referred to as being “directly on” or extending “directly onto” another element, there are no intervening elements present, except in some examples an attach material (e.g., die-attach material, solder, paste, adhesive, sintered material or other material may be present. It will also be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present, except in some examples an attach material (e.g., die-attach material, solder, paste, adhesive, sintered material or other material may be present.

Relative terms such as “below” or “above” or “upper” or “lower” or “horizontal” or “lateral” or “vertical” may be used herein to describe a relationship of one element, layer or region to another element, layer or region as illustrated in the figures. It will be understood that these terms are intended to encompass different orientations of the device in addition to the orientation depicted in the figures.

Embodiments of the disclosure are described herein with reference to cross-section illustrations that are schematic illustrations of idealized embodiments of the disclosure. The thickness of layers and regions in the drawings may be exaggerated for clarity. Additionally, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing. Similarly, it will be understood that variations in the dimensions are to be expected based on standard deviations in manufacturing procedures. As used herein, “approximately” or “about” includes values within 10% of the nominal value.

Like numbers refer to like elements throughout. Thus, the same or similar numbers may be described with reference to other drawings even if they are neither mentioned nor described in the corresponding drawing. Also, elements that are not denoted by reference numbers may be described with reference to other drawings.

Some embodiments of the invention are described with reference to semiconductor layers and/or regions which are characterized as having a conductivity type such as n type or p type, which refers to the majority carrier concentration in the layer and/or region. Thus, N type material has a majority equilibrium concentration of negatively charged electrons, while P type material has a majority equilibrium concentration of positively charged holes. Some material may be designated with a “+” or “−” (as in N+, N−, P+, P−, N++, N−−, P++, P−−, or the like), to indicate a relatively larger (“+”) or smaller (“−”) concentration of majority carriers compared to another layer or region. However, such notation does not imply the existence of a particular concentration of majority or minority carriers in a layer or region.

Those of ordinary skill in the art, using the disclosures provided herein, will understand that aspects of the present disclosure may be used with any semiconductor material, such as wide band gap semiconductor materials, without deviating from the scope of the present disclosure. Example wide band gap semiconductor materials include silicon carbide (e.g., 2.996 eV band gap for alpha silicon carbide at room temperature) and the Group III-nitrides (e.g., 3.36 eV band gap for gallium nitride at room temperature).

In the drawings and specification, there have been disclosed typical embodiments and, although specific terms are employed, they are used in a generic and descriptive sense only and not for purposes of limitation of the scope set forth in the following claims.

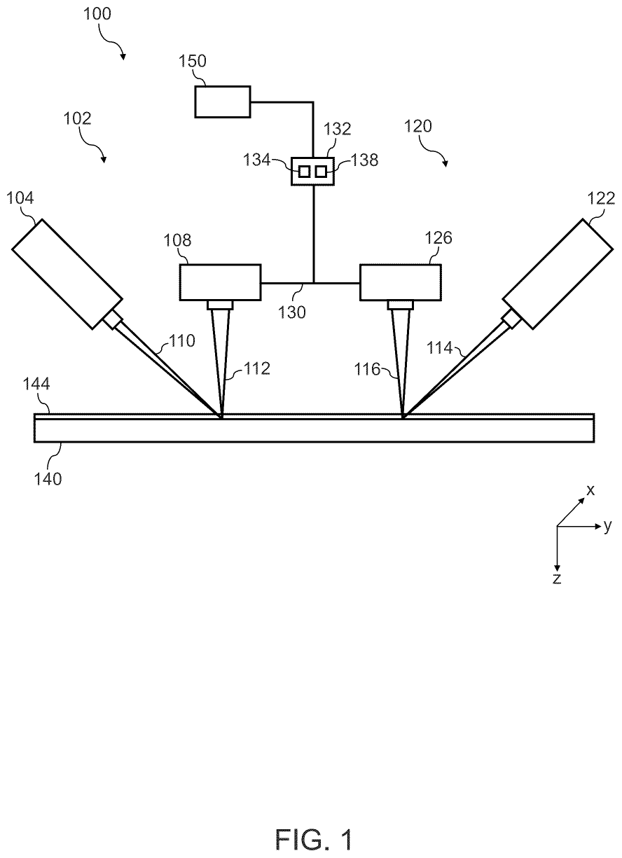

FIG. 1 depicts an example semiconductor workpiece imaging system 100 according to example embodiments of the present disclosure. It should be understood that FIG. 1 is intended to represent structures for purposes of identification and description and is not intended to represent the structures to physical scale.

The semiconductor workpiece imaging system 100 may include a first imaging device 102 and a second imaging device 120. The semiconductor workpiece imaging system 100 may further include a controller 132. The first imaging device 102 may include a first radiation source 104 and a first detector 108. The second imaging device 120 may include a second radiation source 122 and a second detector 126. The first radiation source 104 and/or the second radiation source 122 may be configured to direct light at a semiconductor workpiece 140.

The semiconductor workpiece 140 may have a front face and a back face opposite the front face. The front face may be proximal the first detector 108 and/or the second detector 126. The first radiation source 104 may direct first incident light 110 onto a first portion of the semiconductor workpiece 140. Additionally or alternatively the second radiation source 122 may direct second incident light 114 onto a second portion of the semiconductor workpiece 140. The first and second portions of the semiconductor workpiece 140 may be the same portion or they may be different. The semiconductor workpiece 140 may direct light at the first portion of the semiconductor workpiece 140 before, concurrent with, or after the second radiation source 122 directs the second incident light 114 at the second portion of the semiconductor workpiece 140.

The first incident light 110 may be reflected and/or transmitted by the semiconductor workpiece 140, resulting in first detectable light 112 that is detected by the first detector 108. The second incident light 114 may be reflected and/or transmitted by the semiconductor workpiece 140, resulting in second detectable light 116 that is detected by the second detector 126. First detectable light 112 and second detectable light 114 is illustrated as reflected light for purposes of illustration and discussion. Those having ordinary skill in the art, using the disclosures provided herein, will understand that the first detectable light 112 and/or second detectable light may be transmitted light. Additionally or alternatively, the first detectable light 112 and/or the second detectable light 116 may be emitted by the semiconductor workpiece 140 as photoluminescence (e.g., fluorescence). For instance, the first incident light 110 and/or the second incident light 114 may excite respective portions of the semiconductor workpiece 140 and result in a delayed light emission by the semiconductor workpiece 140.

In some examples, the first incident light 110 and/or the second incident light 114 are transmitted through the semiconductor workpiece 140. For instance, the first incident light 110 and/or the second incident light 114 may include a wavelength of light or other aspect of light that allows the light to substantially pass through the semiconductor workpiece 140. For instance, in some examples, the first incident light 110 and/or the second incident light 114 comprises infrared light (e.g., near-infrared (NIR) light), green light (e.g., wavelength of about 515 nm to about 570 nm), red light (e.g., wavelength of about 630 nm to about 700 nm).

The first radiation source 104 and/or the second radiation source 122 may be configured to emit light that is polarized (e.g., elliptically, linearly) or unpolarized, pulsed or continuous, coherent or incoherent, visible or invisible, and/or light of one or more wavelengths or wavelength ranges.

The first imaging device 102 and/or the second imaging device 120 may obtain workpiece images from the surface of the semiconductor workpiece 140. The workpiece images may have a resolution described herein, which may be dependent in part on a resolution of the first imaging device 102 and/or the second imaging device 120. As one example, the resolution may have approximately 1 micron per pixel to about 10 microns per pixel. However, in some examples, the resolution may be less than 1 micron per pixel. The imaging device 102, 120 may include any suitable imaging device, such as a PL microscope, x-ray topographic imaging source, cross-polarized light imaging (e.g., birefringent contrast imaging) source, camera, infrared camera, camera associated with non-visible light wavelengths, scanning electron microscope, or other suitable device configured to obtain data associated with spatial coordinates of the workpiece.

In some examples, the semiconductor workpiece imaging system 100 may include one or more detectors, such as the first detector 108 and/or the second detector 126, for obtaining image data associated with the semiconductor workpiece 140. In some examples, the image data may be processed to determine workpiece characterization data for the semiconductor workpiece 140. Workpiece characterization data is data that provides information associated with one or more workpiece characteristics of the semiconductor workpiece 140, such as topography, surface roughness, parallelism, optical wedge(s), presence of anomalies, doping, thickness, and/or other characteristics. In some examples, workpiece characterization data may include, for instance, an image of the surface of the semiconductor workpiece 140 and/or a topological map of the surface of the semiconductor workpiece 140.

In some examples, the one or more detectors 108, 126 may include one or more surface measurement lasers, depth sensors, illuminator, or other sensors that may be operable to emit a laser or other light onto the surface of the semiconductor workpiece 140 and scan the surface (e.g., based on reflections of the light) for depth measurements, topography measurements, etc. of the surface of the semiconductor workpiece 140. Other suitable sensors may be used without deviating from the scope of the present disclosure.

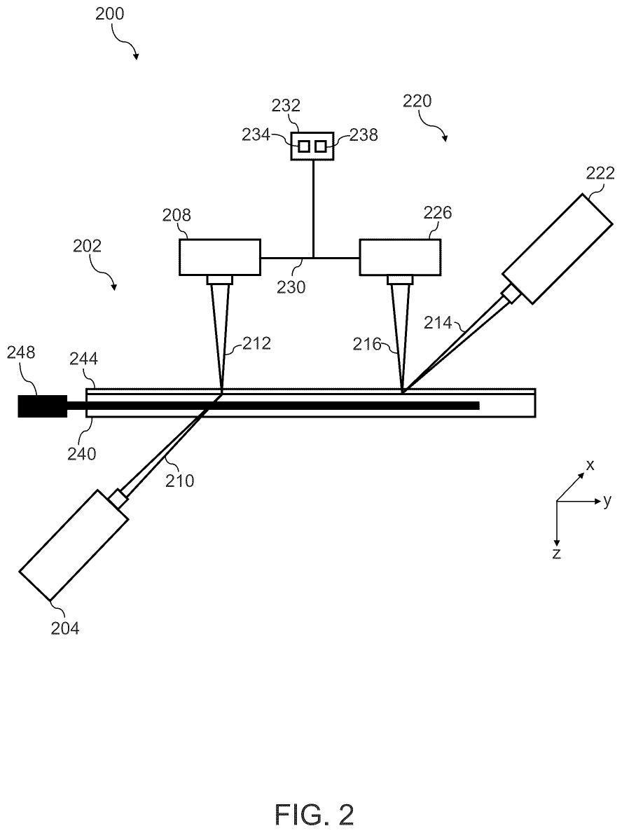

In some examples, the semiconductor workpiece imaging system 100 includes a fiducial structure 144. The fiducial structure 144 may be on the semiconductor workpiece 140 and/or on a workpiece holder (not shown in FIG. 1, but see workpiece holder 248 of FIG. 2). The fiducial structure 144 may be configured to be visible by one or more of the first imaging device 102 and/or the second imaging device 120. The fiducial structure 144 may be etched into, layered on (e.g., using evaporation), attached to, or otherwise formed as part of the semiconductor workpiece 140 and/or the workpiece holder. The fiducial structure 144 may include one or more fiducial markers individually identifiable by the first imaging device 102 and/or the second imaging device 120.

In some examples, the semiconductor workpiece imaging system includes a sensor 150. The sensor 150 may be configured to identify, characterize, or otherwise analyze characterization data about the semiconductor workpiece 140, such as, by way of non-limiting example, topography, roughness, presence of anomalies, doping, thickness, and/or other characteristics of the semiconductor workpiece 140. The sensor 150 may include an imaging sensor, a feature sensor, a RADAR sensor, a LIDAR sensor, a thermal sensor, and/or the like. It should be understood that the sensor 150 may be any suitable sensor operable to obtain feature data and/or other data described herein for characterizing the semiconductor workpiece 140 without deviating from the scope of the present disclosure.

The semiconductor workpiece imaging system 100 may additionally and/or alternatively include control circuitry having one or more processor(s), one or more non-transitory computer-readable media, and/or the like. For instance, as shown, the semiconductor workpiece imaging system 100 may include a controller 132 that includes a memory 134 and a processor 138. The memory 134 may include one or more memory devices, and/or the processor 138 may include one or more processors. The processor 138 may include an electronic and/or hardware processor. The memory 134 may include non-transitory memory. The memory 134 may store computer-readable instructions that when executed by the processor 138 cause the memory 134 to perform one or more control functions, such as any of the functions described herein. Additionally and/or alternatively, in some examples, the memory 134 may store one or more machine-learned models operable to perform any of the functions described herein.

The controller 132 may be in communication with various other aspects of the semiconductor workpiece imaging system 100 through one or more wired and/or wireless control links, such as the communication interface 130. The communication interface 130 may be a wired and/or wireless data communication link informationally connecting the first imaging device 102 (e.g. via the first detector 108), the second imaging device 120 (e.g., via the second detector 126), and/or the controller 132. The controller 132 may send control signals to the various components of the semiconductor workpiece imaging system 100 (e.g., the workpiece holder, the imaging device 102, 120, etc.) to implement the aspects of the present disclosure described herein. Additionally, the controller 132 may include one or more imaging models (e.g., machine-learned models) for inspecting and/or characterizing the semiconductor workpiece 140, as described herein. For instance, by way of non-limiting example, the controller 132 (e.g., via the processor 138) may be configured to determine one or more workpiece characteristics (e.g., defects, surface roughness, parallelism, optical wedge(s), anomalies, doping, thickness, etc.) of the semiconductor workpiece 140 based at least in part on composite image data associated with the semiconductor workpiece 140. Additionally and/or alternatively, in some examples, the controller 132 (e.g., via the processor 138) may be configured to generate feedback data indicative of one or more defects associated with a fabrication process (e.g., a crystal growth process, a grinding process, a lapping process, a polishing process, etc.) of the semiconductor workpiece 140. In some examples, the controller 132 may be configured to provide image data associated with a plurality of images to a machine-learned model and determine one or more workpiece characteristics and/or defects associated with the semiconductor workpiece 140 based at least in part on an output obtained from the machine-learned model.

FIG. 2 depicts an example semiconductor workpiece imaging system 200 according to example embodiments of the present disclosure. The semiconductor workpiece imaging system 200 may include a birefringent contrast imaging device 202 and a photoluminescence imaging device 220. It should be understood that FIG. 2 is intended to represent structures for purposes of identification and description and is not intended to represent the structures to physical scale.

As shown, the semiconductor workpiece imaging system 200 may include the birefringent contrast imaging device 202, the photoluminescence imaging device 220, the semiconductor workpiece 240, the workpiece holder 248, and/or the controller 232. The birefringent contrast imaging device 202 may include a radiation source 204 and a detector 208. In some examples, the birefringent contrast imaging device 202 includes certain beam-modifying elements configured to control a beam shape, size, direction, and/or other aspect of the beam characteristics.

The radiation source 204 may be configured to generate and direct incident polarized light 210 at the semiconductor workpiece 240. The radiation source 204 may include a coherent radiation source, such as a laser. In some examples, the radiation source 204 may output infrared light, such as near-infrared (NIR) light. In some examples, the radiation source 204 may output green light (e.g., 515 nm to about 570 nm), red light (e.g., about 660 nm to about 700 nm) or light of other suitable wavelength range. The incident polarized light 210 may be linearly or circularly polarized light. In some examples, the radiation source 204 may be configured to output despeckled light. For instance, the birefringent contrast imaging device 202 may include a spatial filter, such as a pinhole or a diffuser. The spatial filter may remove high spatial frequency components of the incident polarized light 210 resulting in a despeckled output. Additionally or alternatively, the birefringent contrast imaging device 202 may introduce controlled fluctuations in the phase or frequency of the incident polarized light 210 over time. This may provide temporal disruptions to the coherence of the incident polarized light 210. Other methods are possible.

The incident polarized light 210 may be used to image and/or characterize one or more surfaces (e.g., front surface proximal to the optical detector 208 as shown, back surface proximal to the light source 204 as shown). The incident polarized light 210 may be at least partially transmitted through the semiconductor workpiece 240 as shown, resulting in transmitted light 212 that may be captured by the optical detector 208. The birefringent characteristics of the workpiece (e.g., silicon carbide) may alter or modify the polarization of the polarized light 210 as it is transmitted through the workpiece 240. This modification in polarity may be detected by the optical detector 208. The optical detector 208 may include at least one of a SPAD (single photon avalanche detector) single line detector, an electron-multiplied CCD (charge coupled device) detector, a charge domain CMOS TDI (time delay and integration) sensor, or other suitable detector. The transmitted light 212 (e.g., as a result of the birefringent nature of the material) may contain information about the one or more surfaces or bulk of the semiconductor workpiece 240. Features (e.g., defects) described above may be visible as dark or light contrasts at the optical detector 208. For instance, a polarization of the incident polarized light 210 may be modified by features found on the one or more surfaces (and/or in the depth or bulk) of the semiconductor workpiece 240. These features may be visible by detecting the transmitted light 212 indicative of the modified polarizations.

In some examples, one or more of the birefringent contrast imaging device 202 and/or the photoluminescence imaging device 220 is configured to generate a darkfield image. Additionally or alternatively, the semiconductor workpiece imaging system 200 may generate a brightfield image using reflected light (e.g., in the birefringent contrast imaging device 202 and/or the photoluminescence imaging device 220). It should be understood that other imaging devices may be used without deviating from the scope of the present disclosure.

The radiation source 204 may be configured (e.g., controlled by the controller 232) to focus the incident polarized light 210 at a target x-, y-, and z-position on or within the semiconductor workpiece 240. The radiation source 204 may scan the focused beam along a first axis (e.g., x-axis, y-axis, z-axis). Such a scan may be referred to as a “line scan”. In some examples, the first axis is the x-axis. In some examples, the first axis is the y-axis. Multiple such line scans may be made along the first axis. The multiple line scans along the first axis may have a width measured along a second axis (e.g., a second axis within the x-y plane). The width can have any value without deviating from the scope of the present disclosure. In some examples, the width may be in a range of about 1 microns to about 50 mm, such as in a range of about 1 mm to about 40 mm, such as in a range of about 4 mm to about 25 mm, such as about 1 micron, about 2 microns, about 3 microns, about 5 microns, about 8 microns, about 10 microns, about 15 microns, about 25 microns, about 35 microns, about 50 microns, about 75 microns, about 100 microns, about 200 microns, about 250 microns, about 500 microns, about 1 mm, about 2 mm, about 3 mm, about 5 mm, about 10 mm, having any value therebetween, or fall within a range having any of those widths as endpoints. In some embodiments, the line scans have a width of about 14 mm to about 25 mm. These line scans may be stitched together along the second axis to create a two-dimensional stitched mapping of the surface (or other depth along the z-axis) of the semiconductor workpiece 240. As described in more detail below, each line scan may be spatially correlated and/or aligned using one or more fiducial markers so that the stitched mapping may be accurately made. In some examples, the line scans may at least partially overlap.

In some examples, controller 232 causes the radiation source 204 to perform this two-dimensional mapping of the semiconductor workpiece 240 at the target z-axis position, and to perform multiple such two-dimensional mappings of the semiconductor workpiece 240. In some examples, each of the two-dimensional mappings may have a depth (in the z-axis) of any width described above regarding the width of the line scans. For instance, in some examples, the depth of the two-dimensional mappings is about 1 mm. These two-dimensional mappings may be further stitched together to create a three-dimensional mapping of the semiconductor workpiece 240. As with the line scans above, the two-dimensional mappings may be aligned and/or spatially correlated with precision based on fiducial markers of the fiducial structure 244 so that the multiple two-dimensional mappings may be properly stitched together for an accurate three-dimensional mapping of the semiconductor workpiece 240.

This three-dimensional mapping may be stored in the memory 234 of the controller 232. In some examples, the three-dimensional mapping may be aligned and/or spatially correlated (e.g., using the fiducial markers of the semiconductor workpiece 240) with a corresponding three-dimensional mapping created using a different modality (e.g., a photoluminescent three-dimensional mapping created using the photoluminescence imaging device 220). Additionally or alternatively, one or more two-dimensional mappings of a first modality (e.g., from the birefringent contrast imaging device 202) may be compared with corresponding two-dimensional mappings of a second modality (e.g., from the photoluminescence imaging device 220). In some examples, individual line scans of the first modality along the first axis may be aligned and/or spatially correlated and compared to (and/or merged with) corresponding line scans of the second modality.

The photoluminescence imaging device 220 may be configured (e.g., under control of the controller 232) to image one or more portions of the semiconductor workpiece 240. The ultraviolet radiation source 222 may direct incident ultraviolet light 214 onto a target surface or at a target depth of the semiconductor workpiece 240. The ultraviolet radiation source 222 may include at least one of a laser, an LED, or an arc lamp. The incident ultraviolet light 214 may be calibrated to be absorbed by the semiconductor workpiece 240, causing the semiconductor workpiece 240 to emit resultant photoluminescent light 216. The photoluminescent light 216 may include fluorescent light.

The photoluminescence detector 226 may be configured to obtain imagery of the target surface or depth of the semiconductor workpiece 240. The photoluminescent light 216 may provide feature (e.g., imperfection, defect) information at the target position of the semiconductor workpiece 240. As described above with regard to the birefringent contrast imaging device 202, the photoluminescence imaging device 220 may obtain one or more line scans of the semiconductor workpiece 240 along a first axis (e.g., x-axis, y-axis). These line scans may be stitched together along a second axis in the x-y plane such that a two-dimensional mapping may be created. The line scan(s) and/or two-dimensional mapping(s) may have one or more features common with those described above with regard to the birefringent contrast imaging device 202. The line scan(s), two-dimensional mapping(s), and/or three-dimensional mapping(s) may include the fiducial markings so that the controller 232 may properly align and/or spatially correlate the line scan(s) and/or corresponding mapping(s) with the appropriate line scans and/or mappings of another modality (e.g., from the birefringent contrast imaging device 202).

The semiconductor workpiece imaging system 200 may additionally or alternatively include a workpiece support or workpiece holder 248. The workpiece holder 248 may be configured to support the semiconductor workpiece 240. The workpiece support may include a chuck (e.g., a vacuum chuck) or other mechanism to secure the semiconductor workpiece 240 during processing by the semiconductor workpiece imaging system 200. Additionally or alternatively, in some implementations, the workpiece holder 248 may provide a surface on which the semiconductor workpiece 240 rests. In some implementations, the workpiece holder 248 may provide for moving, rotating, angling, or otherwise reorienting the semiconductor workpiece 240 relative to the rest of the semiconductor workpiece imaging system 200. In some examples, the workpiece holder 248 provides a support surface along a peripheral edge of the semiconductor workpiece 240 so that light or other radiation may be transmitted through the semiconductor workpiece 240 without obstruction by the workpiece holder 248. In some examples, the semiconductor workpiece imaging system 200 may include a workpiece handling robot operable to move the workpiece to the workpiece holder 248.

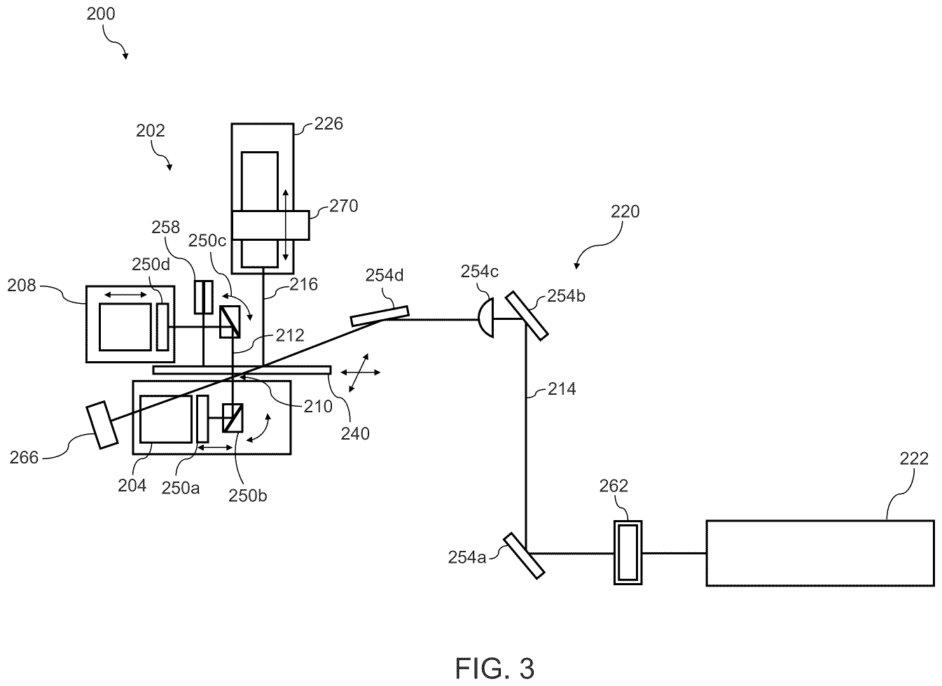

FIG. 3 depicts the example semiconductor workpiece imaging system 200 described above with reference to FIG. 2 according to example embodiments of the present disclosure. As shown, the semiconductor workpiece imaging system 200 includes a birefringent contrast imaging device 202 and a photoluminescence imaging device 220. The birefringent contrast imaging device 202 includes a radiation source 204, a detector 208, one or more first optical elements 250a-d, an illuminator 258, and/or a power meter 266. However, although not depicted, it should be understood that the birefringent contrast imaging device 202 may have other suitable configurations, such as, by way of non-limiting example, using telecentric lenses and/or mirrors to accommodate capturing one or more images of on-axis and/or off-axis workpieces.

For on-axis workpieces, the birefringent contrast imaging device 202 may provide incident light so that it is parallel to the optical axis of the workpiece (e.g., c-axis of a 4H or 6H silicon carbide workpiece) so that the polarization of the incident light is modified by the birefringent nature of the material. For on-axis workpieces (e.g., on-axis 4H or 6H silicon carbide) the incident light may be perpendicular to the workpiece. For off-axis workpieces (e.g., 4° off-axis 4H or 6H silicon carbide) the incident light may be off-axis relative to the workpiece (e.g., not perpendicular) so that the incident light is aligned or nearly aligned with the off-axis c-axis of the workpiece.

Furthermore, in some examples, the photoluminescence imaging device 220 additionally or alternatively includes a power meter 266. For instance, as shown and as will be described in greater detail below, the power meter 266 may be in the path of the incident ultraviolet light 214 and may be operable to detect an amount of light transmitted through the semiconductor workpiece 240.

As shown in FIG. 3, the radiation source 204 may be configured to be movable along an x-axis. In some examples, the radiation source 204 is moveable along two or three axes. This movement allows the controller (not shown) to focus the incident polarized light 210 onto the target location on or within the semiconductor workpiece 240, as well as to scan the semiconductor workpiece 240 along one or more target axes. Additionally or alternatively, the birefringent contrast imaging device 202 may include one or more first optical elements 250a-d that may aid in movement, beam characteristics, and/or focusing of the incident polarized light 210. For instance, the optical element 250a may include a polarizing element, such as a polarizer. The polarizing element may include a waveplate (e.g., half waveplate, quarter waveplate) and/or a polarizing beamsplitter. In some examples, the optical element 250a may include an optical filter. Such an optical filter may, for instance, be used to select for a particular wavelength of light that will image the features on or within the semiconductor workpiece 240.

Additional elements, such as the optical element 250b and/or the optical element 250c may be included to control the beam of the incident polarized light 210. The optical element 250b and/or the optical element 250c may include reflective elements, such as mirrors and/or beamsplitters. As indicated in FIG. 3, one or more of the optical elements 250b, 250c may be configured to rotate along one or more axes. Additionally or alternatively, they may be able to translate along one or more axes. Such degrees of freedom may allow for a high level of precision in directing the beam path through and to focus the beam at the target location of the semiconductor workpiece 240. It may be advantageous to effectively rotate the incident polarized light 210 by a target amount (e.g., 90 degrees). For instance, it may be helpful to change which portion of the incident polarized light 210 is the ordinary and which is the extraordinary relative to the particular orientation of the semiconductor workpiece 240. In some examples, it may be possible to simultaneously image the same location of the semiconductor workpiece 240 along both axes, perhaps using a polarizing beamsplitter to direct both ordinary and extraordinary beams at the same target location simultaneously.

In some examples, the optical elements 250b, 250c include compensators, such as retardation plates. The compensators may introduce a controlled phase delay between the orthogonal components of the incident polarized light 210. Additionally or alternatively, they may adjust the relative phase between the ordinary and extraordinary rays passing through the semiconductor workpiece 240. This may allow for the observation of interference patterns and enhancing contrast of any features in the semiconductor workpiece 240.

The optical element 250d may include another polarizer. For instance, the optical element 250d may include an analyzer. The analyzer, for a workpiece with no changes in optical polarization, should completely block the incident light for a cross-polarization modality. The birefringence of the sample may change the polarization of the incident light, so that it is not totally blocked by the analyzer at the site of defects. The optical element 250d may be oriented at a specific angle relative to another polarizer (e.g., the optical element 250a).

In some examples, the birefringent contrast imaging device 202 may include an illuminator 258. The illuminator 258 may be configured to illuminate a surface of the semiconductor workpiece 240. The illuminator 258 may be configured to output light, but other wavelength ranges are also possible. The illuminator 258 may emit light suitable to facilitate capturing line scan images of the workpiece 240. The illuminator 258 may be a source of monochromatic light that has close to a single polarization. In some examples, the illuminator 258 is a laser. In some examples, the illuminator 258 is an LED with some wavelength spread. The illuminator 258 may provide linearly or circularly polarized light.

In some embodiments, the illuminator 258 may include or be a part of a confocal chromatic sensor. The confocal chromatic sensor can focus a radiation source of at least one of the first or second imaging devices. The confocal chromatic sensor can be configured to be independently operable from one or both of the photoluminescence imaging device 202 and/or the birefringent contrast imaging device 220. The confocal chromatic sensor may obtain data indicative of a distance to the semiconductor workpiece 240 and/or a thickness of the semiconductor workpiece 240 (e.g., to act as a depth sensor for the system). Additionally or alternatively, the photoluminescence imaging device 202 can be configured to be adjusted independent of the birefringent contrast imaging device 220 based on data received from the confocal chromatic sensor. In some embodiments, the confocal chromatic sensor and/or a separate illuminator can illuminate a face of the semiconductor workpiece 240.

The photoluminescence imaging device 220 may include an ultraviolet radiation source 222, a photoluminescence detector 226, one or more second optical elements 254a-d, a light attenuator 262, and/or an optical filter 270. The ultraviolet radiation source 222 may include a coherent radiation source, such as a laser. In some examples, the light attenuator 262 may be included to help modulate (e.g., reduce) an intensity of the ultraviolet radiation source 222. This may be valuable, for instance, in situations where the laser output of the ultraviolet radiation source 222 is too strong for the semiconductor workpiece 240 or if precise control over the laser power is needed. Damaging the semiconductor workpiece 240 due to a laser intensity would be counterproductive to identifying and mitigating defects or other features on or in the semiconductor workpiece 240. The light attenuator 262 may absorb and/or scatter a portion of the laser light passing therethrough. This may reduce the beam intensity without significantly altering its properties such as its spatial and temporal characteristics.

In some examples, the photoluminescence imaging device 220 includes one or more of the second optical elements 254a-d shown. The optical elements 254a, 254b, 254d may include reflective optical elements, such as mirrors (e.g., dielectric mirrors, dichroic mirrors). The reflective optical elements may be configured to reflect a particular wavelength or range of wavelengths. The optical element 254c may be a refractive optical element, such as a lens. The lens may be configured to be a focusing lens and/or a collimating lens. The second optical elements 254a-d may be helpful in controlling a shape, direction, and/or other characteristics of the beam of light from the ultraviolet radiation source 222. In some examples, the controller (not shown) may automatically control one or more of the second optical elements 254a-d (and/or the first optical elements 250a-d).

The photoluminescence detector 226 may be configured to detect photoluminescence, such as fluorescence. The photoluminescence detector 226 may include one or more of photomultiplier tubes, avalanche photodiodes, a CCD sensor, and/or a CMOS sensors. The photoluminescence detector 226 may be configured to detect one or more ranges of fluorescence, such as about 400-450 nm (e.g., blue emissions), about 500-600 nm (e.g., green emissions), about 600-700 nm (e.g., red emissions), about 700-1100 nm (e.g., infrared emissions). As indicated in FIG. 3, the photoluminescence detector 226 may be configured to be movable along one or more degrees of freedom. For instance, the photoluminescence detector 226 may be translatable along a z-axis. Other degrees of freedom, such as x- and/or y-axis translations may be possible. In some examples, the photoluminescence detector 226 may be rotated along one or more of the x-, y-, and/or z-axis. The controller may be configured to control these movements.

In some examples, the photoluminescence detector 226 may include the optical filter 270. The optical filter 270 may include a filter wheel including a plurality of optical filters, such as wavelength range filters. The optical filter 270 may be controllable by the controller. In some examples, the optical filter 270 includes filters for one or more of the ranges of fluorescence (e.g., blue fluorescence, green fluorescence, red fluorescence, infrared fluorescence) described above.

In some examples, the semiconductor workpiece imaging system 200 may include the power meter 266. The power meter 266 may measure and in some examples control (e.g., at the direction of the controller) a power output by the radiation source 204 and/or from the ultraviolet radiation source 222. The power meter 266 may include a sensor that tracks an amount of power provided by the target radiation source (e.g., the radiation source 204, the ultraviolet radiation source 222). In some examples, the power meter 266 may additionally or alternatively serve as a light attenuator to provide a minimum or maximum power intensity of the target radiation source. The power meter 266 may measure the power intensity electrically or optically. For instance, the power meter 266 may be in electrical communication with the radiation source to measure and/or control the power intensity of the radiation source. Additionally or alternatively, the power meter 266 may receive a portion (e.g., a split portion) of the incident polarized light 210 and/or the transmitted light 212 to determine an intensity of the radiation. In some examples, the power meter 266 may increase or decrease the intensity output by the power meter 266. Modifying the intensity of the output light may help ensure that the semiconductor workpiece 240 is not damaged by an overly intense incident polarized light 210. Additionally or alternatively, the power meter 266 may help ensure that the transmitted light 212 is sufficiently intense that the detector 208 may pick up the signal of the features during imaging.

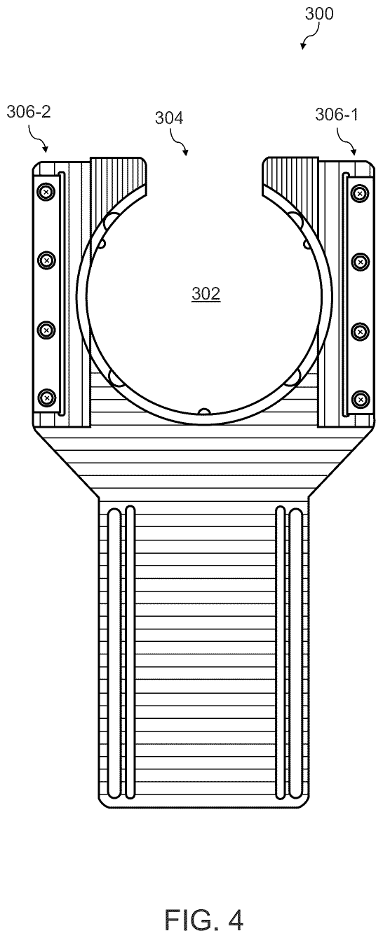

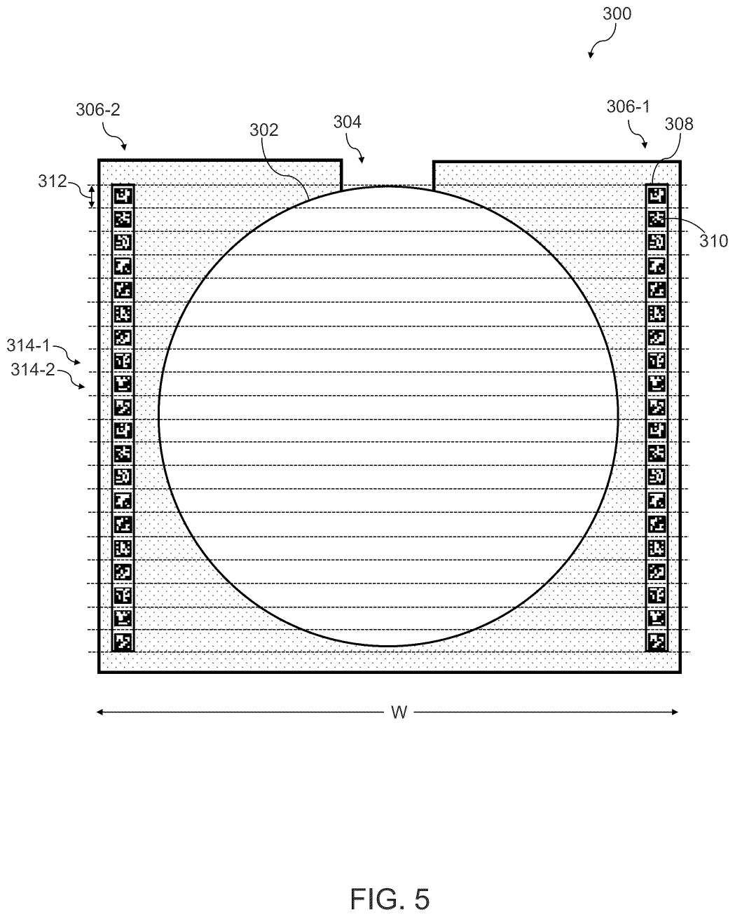

FIGS. 4-5 depict an example workpiece holder 300 according to example embodiments of the present disclosure. More particularly, FIG. 4 depicts a top perspective view of the example workpiece holder 300, and FIG. 5 depicts a close-up plan view of a top portion of the example workpiece holder 300. It should be understood that FIGS. 4-5 are intended to represent structures for purposes of identification and description and are not intended to represent the structures to physical scale.

The example workpiece holder 300 depicted in FIGS. 4-5 may be similar to any of the workpiece holders described herein, such as the workpiece holder 248 discussed above with reference to FIGS. 1-3. For instance, the workpiece holder 300 may be operable to hold and/or support a workpiece 302. More particularly, as shown, the workpiece holder 300 may include a receptacle 304 operable to receive the workpiece 302. It should be understood that the workpiece 302 may be similar to any of the workpieces described herein, such as the semiconductor workpiece 140 (FIG. 1), the semiconductor workpiece 240 (FIGS. 2-3), and/or the like. For instance, in some examples, the workpiece 302 may be a semiconductor workpiece that includes a silicon carbide crystalline material. The silicon carbide crystalline material may have a 4H crystal structure, 6H crystal structure, or other crystal structure. The semiconductor workpiece can be an on-axis workpiece (e.g., end face parallel to the (0001) plane) or an off-axis workpiece (e.g., end face non-parallel to the (0001) plane), such as a 2°, 4°, 6°, or 8° off-axis workpiece.

The workpiece holder 300 may also include one or more fiducial structures 306, such as a first fiducial structure 306-1 and a second fiducial structure 306-2 (collectively “fiducial structure(s) 306”). Those having ordinary skill in the art, using the disclosures provided herein, will appreciate that the fiducial structure 306 may be similar to any of the fiducial structures described herein, such as the fiducial structure 144 (FIG. 1), the fiducial structure 244 (FIGS. 2-3), and/or the like. In some examples, each fiducial structure 306 may be on a peripheral side of the workpiece holder 300. For instance, as shown in FIGS. 4-5, the first fiducial structure 306-1 may be on a peripheral side of the workpiece holder 300, and the second fiducial structure 306-2 may be on an opposing peripheral side of the workpiece holder 300 from the first fiducial structure 306-1. Put differently, the workpiece holder 300 may be configured such that the receptacle 304 and, hence, the workpiece 302 may be between the first fiducial structure 306-1 and the second fiducial structure 306-2.

The fiducial structures 306 may include a semiconductor structure 308. The semiconductor structure 308 may include a semiconductor material. In some examples, the semiconductor structure 308 may include the same semiconductor material as the workpiece 302. By way of non-limiting example, the semiconductor structure 308 may include a wide bandgap semiconductor, such as silicon carbide (SiC). However, those having ordinary skill in the art, using the disclosures provided herein, will appreciate that the semiconductor structure 308 may include any suitable semiconductor material without deviating from the scope of the present disclosure. In some examples, an optical axis (e.g., c-axis for 4H or 6H hexagonal crystal structure) of the semiconductor structure 308 is aligned with the optical axis of the semiconductor material of the semiconductor workpiece.

The fiducial structures 306 may further include one or more fiducial markers 310 on the semiconductor structure 308. In some examples, each of the one or more fiducial markers 310 may include at least one of an ArUco pattern, an AprilTag pattern, a CALTag pattern, an ARTag pattern, and/or the like. It should be understood that the fiducial structures 306 are depicted as having one column of fiducial markers 310 for purposes of illustration and discussion. Those having ordinary skill in the art, using the disclosures provided herein, will understand that a fiducial structure of the present disclosure may include any number of fiducial markers having any suitable pattern without deviating from the scope of the present disclosure.

As will be discussed in greater detail below, each fiducial marker 310 may include an internal first region of a material of first optical characteristics and a second region at least partially around the internal first region. The second region may be a material having second optical characteristics that are different from the first optical characteristics. In some examples, the first region may transmit light in a transmission-based light imaging modality (e.g., birefringent contrast imaging modality). The second region may not transmit light in the transmission-based light imaging modality (e.g., birefringent contrast imaging modality). The first region may emit light in an emission-based light imaging modality (e.g., photoluminescence imaging modality). The second region may not emit light in an emission-based light imaging modality (e.g., photoluminescence imaging modality). The first region may not reflect light in a reflection-based imaging modality. The second region may reflect light in the reflection-based imaging modality. In some examples, the first region is a non-metal region and the second region is a metal region. However, other suitable materials may be used for the second region, such as ceramic materials (e.g., ZnO, ZnS) without deviating from the scope of the present disclosure.

In some examples, the first region is an internal non-blocking region and the second region is a blocking region at least partially around the internal non-blocking region. The first region is referred to as a “non-blocking” region because for a transmission-based imaging modality (e.g., birefringent contrast imaging), the non-blocking region may not block light incident on the fiducial marker at the wavelength of light incident on the workpiece (e.g., transmits at least 50% of light through the material, such as in a range of 50% to 100%). The second region is referred to as a “blocking region” because for a transmission-based imaging modality (e.g., birefringent contrast imaging modality), the blocking region may block light incident on the fiducial marker at the wavelength(s) of light incident on the workpiece (e.g., transmits less than 50% of light through the material, such as in a range of 0% to 49%).

The blocking region of each fiducial marker 310 may include a metal. However, in some embodiments, the blocking region may be another blocking material, such as a ceramic material, such as ZnO, ZnS, or the like. The internal non-blocking region of each fiducial marker 310 may include a non-metal material, such as silicon nitride (SiN), a phosphor material, and/or the like. The internal non-blocking region of each fiducial marker 310 may be transmissive to incident light when imaged by an imaging device, such as any of the imaging devices described herein; the blocking region of each fiducial marker 310 may be non-transmissive and/or non-emissive when imaged by an imaging device, such as any of the imaging devices described herein. For instance, in some examples, the internal non-blocking region of each fiducial marker 310 may emit light when exposed to ultraviolet radiation, and the blocking region of each fiducial marker 310 may be non-emissive of light when exposed to ultraviolet radiation. In this way, the one or more fiducial markers 310 may be detectable in a plurality of different image modalities, such as two or more of a birefringent contrast image modality, a photoluminescence image modality, a reflectance imaging modality, and/or the like.

As described above, the fiducial structures 306 may be used by an imaging system (e.g., semiconductor workpiece imaging system 100 (FIG. 1), semiconductor workpiece imaging system 200 (FIGS. 2-3)) to align and/or spatially correlate a plurality of images of the workpiece 302. More particularly, an example imaging system may include one or more imaging devices (e.g., first imaging device 102 and second imaging device 120 (FIG. 1), birefringent contrast imaging device 202 and a photoluminescence imaging device 220 (FIGS. 2-3), etc.). The one or more imaging devices may be operable to obtain a plurality of images 312 in a plurality of different image modalities by scanning a width W of the workpiece 302 between the first fiducial structure 306-1 and the second fiducial structure 306-2, and each image 312 may include a portion of the workpiece 302 and at least one fiducial marker 310. There may be overlap between scans.

In some examples, the example imaging system may be operable to determine spatial coordinates for each image of the plurality of images (e.g., based at least in part on the at least one fiducial marker 310 included in each respective image) in each image modality of the plurality of image modalities. In such examples, the imaging system may be further operable to spatially correlate each image of the plurality of images in each image modality of the plurality of image modalities based at least in part on the respective spatial coordinates of each image. In this way, the fiducial structures 306 may serve as an anchor point and/or reference point for determining the spatial coordinates of the plurality of images. It should be understood that, although depicted as including only one fiducial marker 310, each image 312 may include any number of fiducial markers 310 without deviating from the scope of the present disclosure.

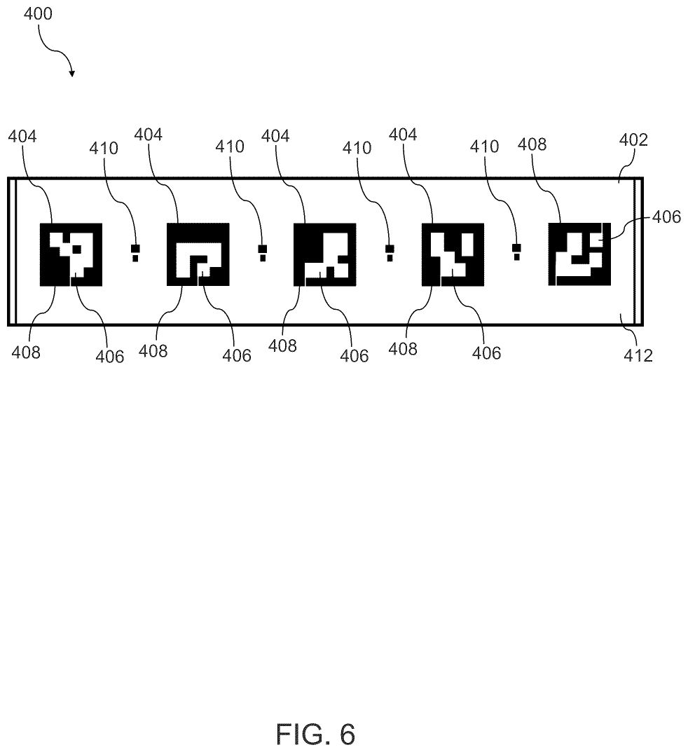

Referring briefly to FIG. 6, a plan view of a portion of an example fiducial structure 400 is depicted according to example embodiments of the present disclosure. The fiducial structure 400 may be similar to any of the fiducial structures described herein, such as the fiducial structure 144 (FIG. 1), the fiducial structure 244 (FIGS. 2-3), the fiducial structures 306 (FIGS. 4-5), and/or the like. It should be understood that FIG. 6 is intended to represent structures for purposes of identification and description and is not intended to represent the structures to physical scale.

Each fiducial marker 404 may include an internal first region of a material of first optical characteristics and a second region at least partially around the internal first region. The second region may be a material having second optical characteristics that are different from the first optical characteristics. In some examples, the first region may transmit light in a transmission-based light imaging modality (e.g., birefringent contrast imaging modality). The second region may not transmit light in the transmission-based light imaging modality (e.g., birefringent contrast imaging modality). The first region may emit light in an emission-based light imaging modality (e.g., photoluminescence imaging modality). The second region may not emit light in an emission-based light imaging modality (e.g., photoluminescence imaging modality). The first region may not reflect light in a reflection-based imaging modality. The second region may reflect light in the reflection-based imaging modality.

In some examples, each fiducial marker 404 may include an internal non-blocking region 406 and a blocking region 408 at least partially around the internal non-blocking region 406. The blocking region 408 of each fiducial marker 404 may include a metal, and the internal non-blocking region 406 of each fiducial marker 404 may include a non-metal material, such as silicon nitride (SiN), a phosphor material, and/or the like. The internal non-blocking region 408 of each fiducial marker 400 may be transmissive to incident light when imaged by an imaging device, such as any of the imaging devices described herein; the blocking region 408 of each fiducial marker 404 may be non-emissive when imaged by an imaging device, such as any of the imaging devices described herein. For instance, in some examples, the internal non-blocking region 406 of each fiducial marker 404 may emit light when exposed to ultraviolet radiation, and the blocking region 408 of each fiducial marker 404 may be non-emissive of light when exposed to ultraviolet radiation. By way of non-limiting example, when exposed to ultraviolet light, the internal non-blocking region 406 may glow in a bright white color, and the blocking region 408 may block the incident light emitted by the internal non-blocking region 406. In this way, the one or more fiducial markers 404 may be detectable in a plurality of different image modalities, such as a birefringent contrast image modality, a photoluminescence image modality, and/or the like. As such, the one or more fiducial markers 404 may serve as anchor points and/or reference points for determining spatial coordinates for a plurality of images (e.g., imaged by the imaging devices described herein) across the plurality of image modalities.

The fiducial structure 400 may further include one or more resolution markers 410. In some examples, such as that depicted in FIG. 6, the one or more resolution markers 410 may be between adjacent fiducial markers 404. Like the fiducial markers 404, at least a portion of the one or more resolution markers 410 may be non-emissive when imaged by an imaging device, such as any of the imaging devices described herein. More particularly, the one or more resolution markers 410 may include a metal. In some examples, the one or more resolution markers 410 may include the same metal as the blocking region 408 of the fiducial markers 404.

A configuration of the one or more resolution markers 410 may provide a precise signal for testing resolution, contrast, distortion, aberrations, and diffraction in imaging systems, such as any of the imaging systems described herein. In this way, the one or more resolution markers 410 may be used to monitor a performance of any of the imaging devices described herein. In some examples, the one or more resolution markers 410 may be one or more Ronchi rulings. By way of non-limiting example, the one or more resolution markers 410 may be one or more Ronchi rulings corresponding to a 1951 USAF resolution test chart defined by the United States Air Force (USAF) MIL-STD-150A standard. Those having ordinary skill in the art, using the disclosures provided herein, will understand that any suitable resolution marker may be used without deviating from the scope of the present disclosure.

The fiducial structure 400 may further include a transparent layer 412 around each of the one or more fiducial markers 404. More particularly, as shown, the transparent layer 412 may be at least partially around the blocking region 408 of the one or more fiducial markers 404. In some examples, the transparent layer 412 may also be around each of the one or more resolution markers 410. Furthermore, in some examples, the transparent layer 412 may be a transparent fluorescent layer that emits light when exposed to ultraviolet radiation. For instance, the transparent layer 412 may include a non-metal material, such as silicon nitride (SiN), a phosphor material, and/or the like. In some examples, the transparent layer 412 may include the same non-metal material as the internal non-blocking region 406 of the one or more fiducial markers 404. In this way, the transparent layer 412 may be transmissive to incident light when imaged by an imaging system, such as any of the imaging devices described herein.

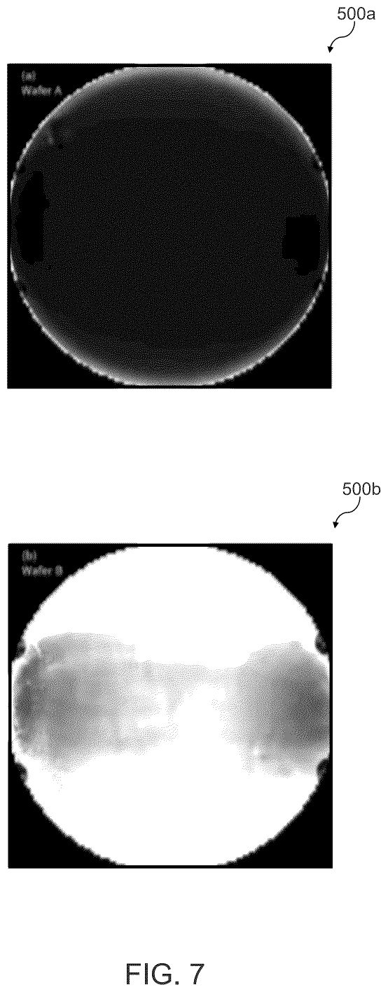

FIG. 7 depicts example workpiece images 500A, 500B of a semiconductor workpiece 502 according to example embodiments of the present disclosure. The semiconductor workpiece 502 may be similar to any of the semiconductor workpieces described herein, such as the semiconductor workpiece 140 (FIG. 1), the semiconductor workpiece 240 (FIGS. 2-3), the workpiece 302 (FIGS. 4-5), and/or the like. It should be understood that FIG. 7 is intended to represent structures for purposes of identification and description and is not intended to represent the structures to physical scale.

The workpiece images 500A, 500B may be obtained and generated by a semiconductor workpiece imaging system (not shown), such as any of the semiconductor workpiece imaging systems described herein (e.g., semiconductor workpiece imaging system 100, semiconductor workpiece imaging system 200, etc.). The workpiece images 500A, 500B may be obtained in the same imaging conditions but with different exposure times. For instance, a radiation source (not shown), such as any of the radiation sources described herein (e.g., radiation source 104, 122 (FIG. 1), radiation source 204, 222 (FIGS. 2-3)), may illuminate the semiconductor workpiece 502 with the same radiation intensity. However, an exposure time associated with the radiation source may differ between the workpiece image 500A and the workpiece image 500B. The workpiece image 500A may be associated with a first exposure time, and the workpiece image 500B may be associated with a second exposure time which is different from the first exposure time. As depicted in FIG. 7, the first exposure time (e.g., associated with the workpiece image 500A) may be shorter than the second exposure time (e.g., associated with the workpiece image 500B).

In some examples, the workpiece images 500A, 500B may be obtained for purposes of workpiece characterization, defect detection, and/or the like. However, as described above, typical scanning processes, such as the scanning process used to obtain the workpiece images 500A and 500B, may be prone to inaccuracies stemming from the imaging conditions, such as the associated radiation intensity and/or exposure time. For instance, the workpiece image 500A is underexposed (e.g., short exposure), which results in an insufficient amount of radiation signal (e.g., provided by the radiation source) received at the detectors (not shown) (e.g., detectors 108, 126 (FIG. 1), detectors 208, 226 (FIGS. 2-3)) to accurately determine one or more workpiece characteristics and/or defects associated with the semiconductor workpiece 502. Likewise, the workpiece image 500B is overexposed (e.g., long exposure), which also results in an insufficient amount of radiation signal (e.g., provided by the radiation source) received at the detectors (not shown) (e.g., detectors 108, 126 (FIG. 1), detectors 208, 226 (FIGS. 2-3)) to accurately determine one or more workpiece characteristics and/or defects associated with the semiconductor workpiece 502.

To address the aforementioned accuracy issues of some scanning processes, example aspects of the present disclosure are directed to a semiconductor workpiece imaging system (e.g., semiconductor workpiece imaging system 100 (FIG. 1), 200 (FIGS. 2-3)) operable to generate a composite workpiece image of a semiconductor workpiece based at least in part on a plurality of images, each of which being associated with exposing at least a portion the semiconductor workpiece at one of a plurality of different radiation intensities. The plurality of images may be captured with constant or the same exposure time. As will be described in greater detail below, in some examples, the composite workpiece image may be a high dynamic range (HDR) image including data associated semiconductor workpiece.

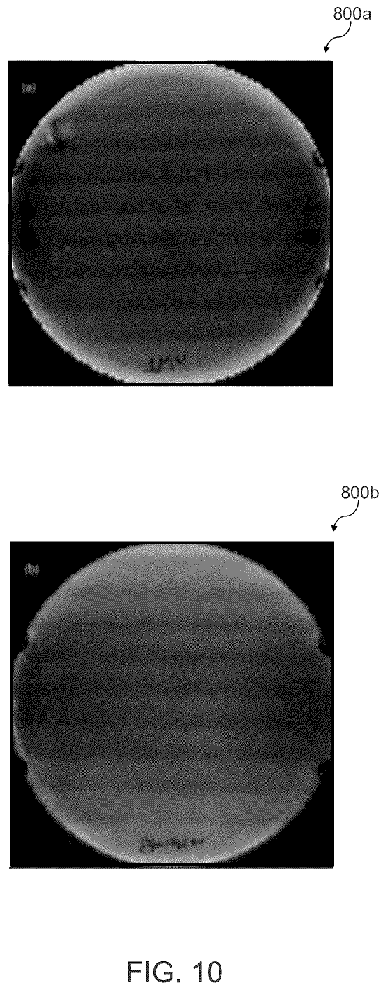

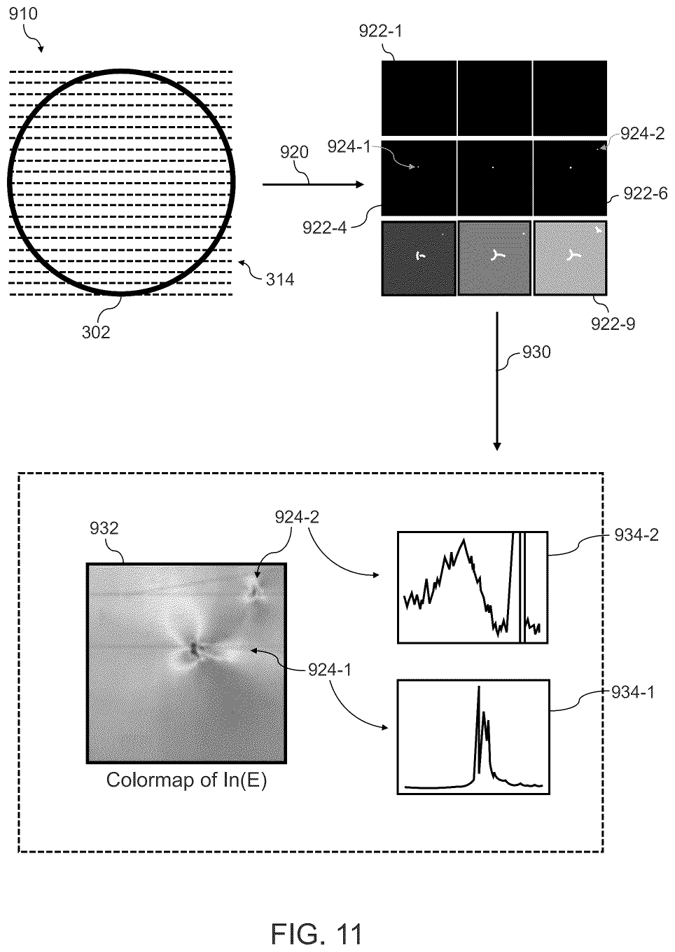

Referring again to FIG. 5, a plurality of images 312 of at least a portion of the workpiece 302 may be obtained by illuminating the workpiece 302 with a radiation source (not shown) (e.g., radiation source 104, 122 (FIG. 1), radiation source 204, 222 (FIGS. 2-3)) at one of a plurality of different radiation intensities, and a composite workpiece image (e.g., composite workpiece image 800A, 800B (FIG. 10), composite workpiece image 932 (FIG. 11)) of at least a portion of the workpiece 302 may be generated based at least in part on the plurality of images 312. In some examples, the radiation source (not shown) may include one or more light-emitting diodes (LEDs), and each of the one or more LEDs may be operable at a plurality of current ratings. In such examples, each radiation intensity associated with the one or more LEDs may correspond to and/or be associated with one of the plurality of current ratings. In some embodiments, the radiation source may include a non-uniform radiation distribution (e.g., greater intensity at a center of a radiation distribution relative to a periphery of the radiation distribution). In these cases, the workpiece may be exposed to different radiation intensities by having overlap of the non-uniform radiation distribution during capturing images of the workpiece. For instance, a first scan of the radiation source may expose a portion of the workpiece to a center of the radiation distribution with a first intensity. A second scan of the radiation source may expose a portion of the workpiece to a periphery of the radiation distribution with a second intensity. The first intensity may be different than the second intensity.

In some examples, the semiconductor workpiece 302 may include a plurality of measurement areas 314, each of which being defined by the portion of the workpiece 302 that is scanned (e.g., along the width W) by the one or more imaging devices (e.g., first imaging device 102 and second imaging device 120 (FIG. 1), birefringent contrast imaging device 202 and a photoluminescence imaging device 220 (FIGS. 2-3), etc.). Each of the plurality of measurement areas 314 may be illuminated for a plurality of illumination instances, and each illumination instance may be associated with one of the plurality of different radiation intensities. As an illustrative example, the one or more imaging devices may illuminate a first measurement area 314-1 at each radiation intensity, and a plurality of image segments of the first measurement area 314-1 may be obtained (e.g., at least one image segment of the plurality of image segments associated with the first measurement area 314-1 may be associated with each of the plurality of different radiation intensities). The plurality of image segments associated with the first measurement area 314-1 may be spatially correlated and/or otherwise combined to generate a composite image segment for the measurement area 314-1. For instance, in some examples, the composite image segment of the first measurement area 314-1 may be a high dynamic range (HDR) image segment and may include data associated with the measurement area 314-1 being illuminated at each of the plurality of different radiation intensities (e.g., data associated with the measurement area 314-1 for each illumination instance).

It should be understood that, as used herein, an “image segment” refers to an image of one measurement area 314 of the workpiece 302. There may be overlap between image segments. In some implementations, the terms “image” and “image segment” may be used interchangeably. Furthermore, as used herein, a “composite image segment” refers to an image segment including data for the corresponding measurement area 314 at each of the plurality of different radiation intensities. Moreover, as used herein, a “composite workpiece image” refers to an image including data for the workpiece 302 at each of the plurality of different radiation intensities. In implementations where a plurality of image segments are obtained, the “composite workpiece image” may include the plurality of composite image segments (e.g., associated with each measurement area 314) spatially correlated and/or otherwise combined such that the composite workpiece image includes data associated with each of the plurality of radiation intensities.

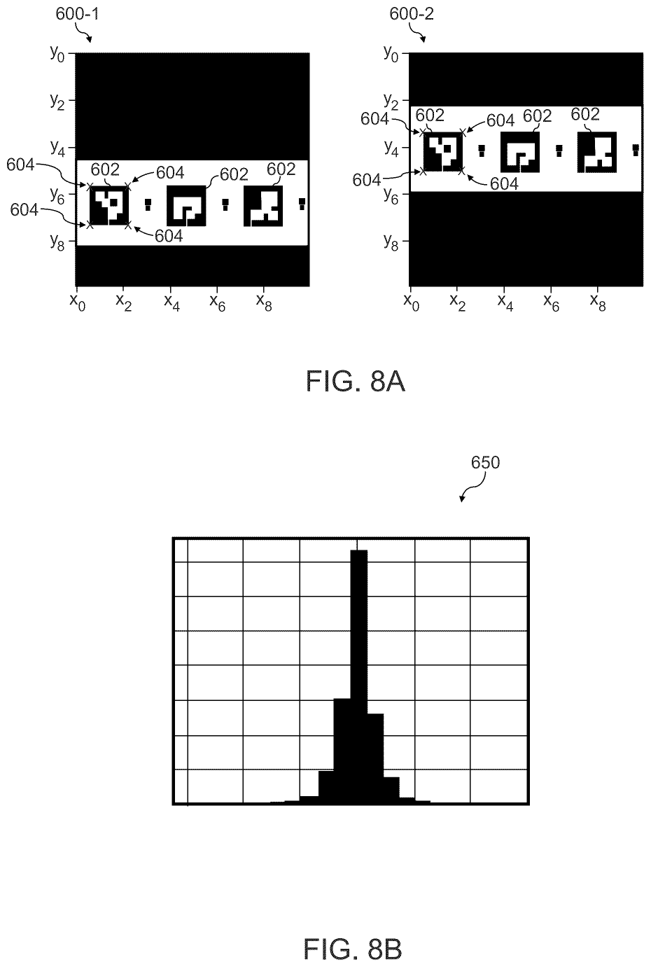

As an illustrative example, FIGS. 8A-8B depict an illustrative example of spatially correlating images of a semiconductor workpiece, such as any of the semiconductor workpieces described herein, according to example embodiments of the present disclosure. More particularly, FIGS. 8A-8B depict an example of spatially correlating the plurality of image segments of the first measurement area 314-1 (FIG. 5). FIG. 8A depicts a portion of a first image segment 600-1 (e.g., associated with a first radiation intensity) and a second image segment 600-2 (e.g., associated with a second radiation intensity) of the first measurement area 314-1. FIG. 8B depicts a correlated plot 650 depicting testing results of the example spatial correlation process described with reference to FIG. 8A. It should be understood that FIGS. 8A-8B are intended to represent structures for purposes of identification and description and is not intended to represent the structures to physical scale.

As shown in FIG. 8A, the first image segment 600-1 and the second image segment 600-2 (collectively, image segments 600) each include a portion of the workpiece 302 and at least one fiducial marker 602. The fiducial markers 602 may be similar to any of the fiducial markers described herein. As shown, although the image segments 600 depict the same portion of the workpiece 302 (e.g., first measurement area 314-1), a variety of system-level factors (e.g., movement of the imaging device(s) and/or the workpiece, etc.) may cause the first image segment 600-1 to be misaligned with the second image segment 600-2. Thus, the image segments 600 may be spatially aligned to address the alignment issues.

More particularly, spatial coordinates 604 for the first image segment 600-1 and the second image segment 600-2 may be determined, and the image segments 600 may then be spatially aligned based at least in part on the spatial coordinates 604 to generate the composite image segment of the measurement area 314-1. In some examples, an algorithm, such as a regression algorithm, may be used to fit an affine transformation, such as a transformation matrix. As one example, the transformation process may be defined by:

$${\overline{X}}^{′} = H \overline{X}$$

$$[ \begin{matrix}{x}^{′} \\ {y}^{′} \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}x \\ y \\ 1\end{matrix} ]$$

where X̅ are the spatial coordinates 604 in the image segments 600, H is the affine transformation matrix, and X̅′ is the transformed spatial coordinates.

In some examples, to reduce inaccuracies along a width W (FIG. 5) of each image segment 600, the spatial coordinates 604 may be scaled such that an aspect ratio of a distribution of the scaled spatial coordinates is approximately equal to one. For instance, the scaled spatial coordinates may be determined based on the following equation:

$$S {\overline{X}}^{′} = {H}_{S} S \overline{X}$$

$$S = [ \begin{matrix}{s}_{11} & 0 & 0 \\ 0 & {s}_{22} & 0 \\ 0 & 0 & 1\end{matrix} ]$$

where S is the scale transformation matrix. Using these equations, the transformation in the scaled coordinate system, H_{S}, may be determined and transformed back to the original coordinate system using an inverse of the scale transformation matrix, S⁻¹, as follows:

$${S}^{- 1} S {\overline{X}}^{′} = {S}^{- 1} {H}_{S} S \overline{X}$$

$$H = {S}^{- 1} {H}_{S} S$$

In this manner, the scaled spatial coordinates for each image segment 600 may be determined based at least in part on the spatial coordinates 604, and an affine transformation for each image segment 600 may be determined based at least in part on the scaled spatial coordinates. The affine transformation may then be transformed (e.g., using an inverse affine transformation) back to the original coordinate system (e.g., associated with the spatial coordinates 604) from the scaled coordinate system (e.g., associated with the scaled spatial coordinates), and the composite image segment of the measurement 314-1 may then be generated. In this manner, the composite image segment may be generated based at least in part on the spatial coordinates 604 associated with each image segment 600.

Referring to FIG. 8B, a correlated plot 650 depicting an alignment error associated with the spatial correlation process described above with reference to FIG. 8A. More particularly, plot 650 is a histogram depicting testing results of alignment error when performing spatial alignments based on one or more fiducial markers (e.g., fiducial markers 602). Plot 650 depicts the alignment error in units of pixels along the x-axis. As shown, spatially correlating the image segments 600 based on the spatial coordinates 604 of the fiducial markers 602 results in an alignment error of less than one pixel.

Referring again to FIG. 5, after the composite image segment of the first measurement area 314-1 is generated, a composite image segment of a second measurement area 314-2 may be obtained. The composite image segment of the second measurement area 314-2 may obtained in a similar manner as described above with reference to the composite image segment of the first measurement area 314-1. In some examples, the same scanning process may be repeated for each measurement area 314 of the workpiece 302 (e.g., with overlap between measurement areas 314), and a composite workpiece image of the workpiece 302 may be generated based at least in part on the composite image segment associated with each measurement area 314.

In some examples, the composite workpiece image may be generated based at least in part on a response function and the plurality of image segments associated with each measurement area 314. More particularly, after aligning the plurality of image segments for each measurement area 314 (e.g., once composite image segments are generated for each measurement area), a response function associated with the one or more imaging devices may be determined so that the composite image of the workpiece 302 may be generated based at least in part on the composite image segments.

As used herein, the “response function” refers to a camera response curve and/or a camera transfer function associated with the one or more imaging devices. The “response function” includes data that describes how the one or more imaging devices convert incoming radiation (e.g., irradiance) to the corresponding digital output data (e.g., pixel intensities, pixel values, etc.). Put differently, the response function characterizes a relationship between a radiance of the scene (e.g., of the workpiece 302) and a radiance in the corresponding image 312 obtained by the semiconductor workpiece imaging system. The response function may map pixel values of the plurality of images to intensity of radiation in a physical space. Thus, example aspects of the present disclosure are operable to determine the response function to linearize the plurality of images 312 and generate the composite workpiece image of the workpiece 302.

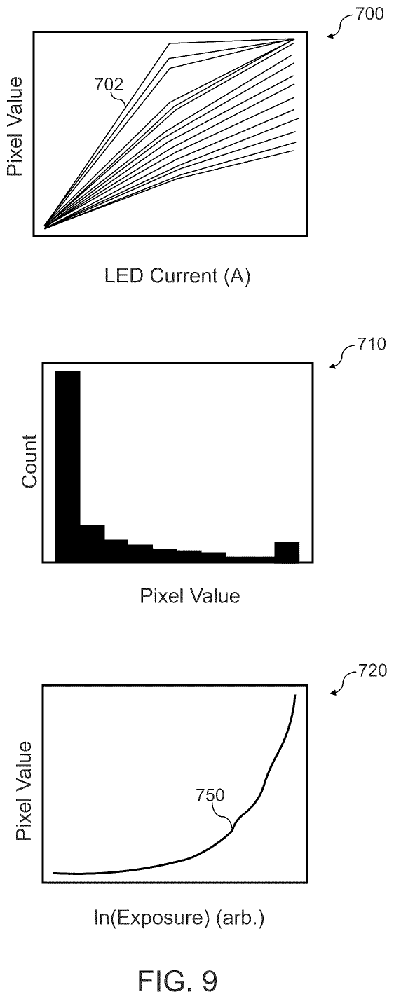

As an illustrative example, FIG. 9 depicts correlated plots 700, 710, 720 of an example response function 750 associated with an example semiconductor workpiece imaging system, such as any of the semiconductor workpiece imaging systems described herein, according to example embodiments of the present disclosure. More particularly, plot 700 depicts a plurality of curves 702, each of which being associated with a pixel in one of the composite image segments associated with one of the plurality of measurement areas 314. Plot 700 includes an x-axis, which depicts different radiation intensities, and a y-axis, which depicts the range of possible pixel values associated with the one or more imaging devices. One or more pixels in each of the composite image segments may be sampled. It should be understood that any number of pixels in the composite image segments may be sampled without deviating from the scope of the present disclosure. As noted above, each composite image segment includes data associated with the corresponding measurement area 314 (FIG. 5) for each illumination instance (e.g., at each radiation intensity). Thus, each pixel may be sampled and, in response, a corresponding pixel value (e.g., depicted along the y-axis) in each illumination instance (e.g., depicted along the x-axis) may be determined.

A pixel value range for each sampled pixel (graphically represented by one of the plurality of curves 702) may be determined based at least in part on the one or more pixel values. Each pixel may be checked to ensure the corresponding pixel value trend is monotonic, which refers to the corresponding pixel values (e.g., depicted on the y-axis) increasing as the radiation intensities (e.g., depicted on the x-axis) likewise increase. In response to determining the pixel value trend is monotonic, the response function 750 may be determined. To increase the accuracy of the resulting composite workpiece image, one or more of the plurality of composite image segments (and/or the one or more pixels therein) may be filtered when a corresponding pixel value range is determined to be non-monotonic (e.g., pixel values decrease as the radiation intensities increase). Plot 710 is a histogram that depicts a distribution of pixel values across the rated dynamic range associated with the one or more imaging devices. More particularly, plot 710 depicts a range of pixel values the one or more imaging devices is operable to detect (e.g., dynamic range) along the x-axis. As shown, the pixel value range for the sampled pixels (e.g., depicted in plot 700) spans the entire dynamic range (e.g., x-axis) of the one or more imaging devices.

In some examples, after determining the response function 750, a composite workpiece image of the workpiece 302 may be generated based at least in part on the response function 750 and the plurality of image segments associated with each of the plurality of measurement areas 314 (FIG. 5). Put differently, the composite workpiece image of the workpiece 302 may be generated based at least in part on the response function 750 and the composite image segments associated with each measurement area 314 (FIG. 5). In some examples, the response function 750 may be determined by solving a system of equations, such as by solving the following quadratic objective function:

$$𝒪 = {\sum }_{i = 1}^{N} {\sum }_{j = 1}^{P} {\{ w ( {Z}_{ij} ) [ g ( {Z}_{ij} ) - ln {E}_{i} - ln Δ {t}_{j} ] \}}^{2} + λ {\sum }_{z = {Z}_{min} + 1}^{{Z}_{max} - 1} {[ w ( z ) {g}^{″} ( z ) ]}^{2}$$

where g is the response function, N is pixels in P photographs (e.g., images), i ranges over pixels and j ranges over exposure durations Δt (e.g., exposure time), w(z) is a weighting function for pixel value z, Zᵢⱼ is the pixel values of pixel location i in image j, E is irradiance, and λ is a scalar.

As an illustrative example, FIG. 10 depicts example composite workpiece images 800A, 800B of the semiconductor workpiece 302 according to example embodiments of the present disclosure. In some examples, the composite workpiece images 800A, 800B may be high dynamic range (HDR) images that depict the workpiece 802 in one of a plurality of image modalities, such as a cross-polarization image modality (e.g., birefringent contrast image modality), a photoluminescence image modality, reflectance image modality, and/or the like. It should be understood that FIG. 10 is intended to represent structures for purposes of identification and description and is not intended to represent the structures to physical scale.

The composite workpiece images 800A, 800B correspond to the workpiece images 500A, 500B (respectively) depicted in and discussed above with reference to FIG. 7. More particularly, like the workpiece image 500A (FIG. 7), the composite workpiece image 800A may be associated with the first exposure time, and, like the workpiece image 500B (FIG. 7), the composite workpiece image 800B may be associated with the second exposure time. As depicted in FIG. 10, the composite workpiece images 800A, 800B depict the workpiece 302 in much greater detail, despite being underexposed (e.g., composite workpiece image 800A) and overexposed (e.g., composite workpiece image 800B) in the same manner as the workpiece images 500A, 500B depicted in FIG. 7. This increased detail, which is the result of exposing at least a portion of the workpiece 302 to a plurality of different radiation intensities, may provide increased accuracy in workpiece characterization processes, defect detection processes, and/or the like.

FIG. 11 depicts an illustrative example of a method 900 for generating a composite workpiece image 932 of the workpiece 302 according to example embodiments of the present disclosure. FIG. 11 depicts example process steps for purposes of illustration and discussion. Those having ordinary skill in the art, using the disclosures provided herein, will understand that the process steps of any of the methods described in the present disclosure may be adapted, modified, include steps not illustrated, omitted, and/or rearranged without deviating from the scope of the present disclosure.

At 910, the workpiece 302 is illuminated by a radiation source (not shown) for a plurality of illumination instances. As noted above, each illumination instance is associated with one of a plurality of different radiation intensities. For instance, in examples where the radiation source is operable to provide radiation to the workpiece 302 at nine different radiation intensities, each measurement area 314 of the workpiece 302 will be illuminated nine times (e.g., one illumination instance for each of the nine radiation intensities). Alternatively, each measurement area 314 may be exposed to nine different radiation intensities as a result of overlapping scans from a radiation source with a non-uniform radiation distribution. Those having ordinary skill in the art, using the disclosures provided herein, will understand that the workpiece may be exposed to different radiation intensity in any manner without deviating from the scope of the present disclosure.

At 920, in response to illuminating the workpiece 302 for the plurality of illumination instances (e.g., at 910), a plurality of images of the workpiece 302 are obtained. In some examples, the plurality of images each are associated with the same exposure time. In some examples, the plurality of images may be a plurality of image segments 922 depicting one of the measurement areas 314 of the workpiece 302. More particularly, at least one image segment may be obtained for each measurement area for each illumination instance. For instance, by way of illustrative example, FIG. 11 depicts a plurality of image segments 922, each of which depicts the same location of the workpiece 302 at each of the plurality of radiation intensities (e.g., for each illumination instance). More particularly, a first image segment 922-1 depicts the portion of the workpiece 302 illuminated at a first radiation intensity, and a ninth image segment 922-9 depicts the portion of the workpiece 302 illuminated at a ninth radiation intensity. As shown, the ninth radiation intensity associated with the ninth image segment 922-9 is stronger than the first radiation intensity associated with the first image segment 922-1. It should be understood that the image segments depicted in FIG. 11 are for purposes of illustration and discussion, and the present disclosure is not limited to obtaining nine image segment at nine radiation intensities.

At 930, a composite workpiece image 932 of the workpiece 302 is generated based at least in part on the plurality of images obtained at 920. More particularly, in some examples, the plurality of images (e.g., image segments 922) obtained at 920 may be spatially correlated to generate a composite image segment for each measurement area 314. The plurality of images (e.g., image segments 922) may be spatially correlated in any suitable manner, such as any of the methods and/or processes described herein. For instance, spatial coordinates for each image segment 922 may be determined, scaled spatial coordinates for each image segment 922 may then be generated based at least in part on the spatial coordinates, an affine transformation for each image segment 922 may then be determined based at least in part on the scaled spatial coordinates, and the composite image segment of the corresponding measurement area 314 may be generated based at least in part on the affine transformation and the corresponding image segment 922. It should be understood that a “composite” image segment includes data associated with each image segment 922, such as data associated with each measurement area 314 for each illumination instance.

In some examples, once a composite image segment for each measurement area 314 has been generated, a response function for the plurality of images (e.g., image segments 922) may be determined (e.g., or a previously determined response function may be accessed, for instance, from a memory device) based at least in part on one or more pixel values associated with each of the plurality of images (e.g., image segments 922). Additionally and/or alternatively, in some examples, the response function may be generated based on the plurality of images (e.g., image segments 922), and the composite image segment for each measurement area 314 may be generated based at least in part on the response function and the plurality of images (e.g., image segments 922). In some examples, the composite image segment may be a high dynamic range (HDR) image segment including data for the corresponding measurement area 314 of the workpiece 302 at each of the different radiation intensities.

The response function for the plurality of images may be determined in any suitable manner, such as any of the methods and/or processes described herein. For instance, one or more pixels in each of the image segments 922 may be sampled and, in response, the one or more corresponding pixel values may be determined. A pixel range associated with each image segment 922 may be determined based at least in part on the one or more pixel values and, in response to determining the pixel value range is monotonic, the response function may be determined for each image segment 922. In some embodiments, the response function may be a previously determined response function that is accessed, for instance, from a memory device.

Once the response function and composite image segment for each measurement area 314 has been generated or otherwise accessed, the composite workpiece image 932 of the workpiece 302 may be generated. It should be understood that only a portion of the composite workpiece image 932 is depicted in FIG. 11—namely, the portion corresponding to the portion of the workpiece 302 depicted in each image segment 922—for purposes of illustration and discussion. Those having ordinary skill in the art, using the disclosures provided herein, will understand that a composite workpiece image of the present disclosure may include data for the workpiece 302 in its entirety, or any suitable portion thereof, without deviating from the scope of the present disclosure.

In some examples, a composite tone map and/or a composite color map of at least a portion of the workpiece 302 may be generated based at least in part on the composite workpiece image 932. For instance, a composite tone map of the workpiece 302 may include data associated with one or more workpiece characteristics of the workpiece 902 in each of the plurality of different radiation intensities associated with the radiation source. More particularly, the composite tone map includes an increased contrast across the wide dynamic range of the composite workpiece image 932. In this way, the composite tone map preserves the details of the composite workpiece image 932 and allowed the composite workpiece image 932 to be viewed or processed with devices having standard dynamic ranges.

Additionally and/or alternatively, a composite color map of the workpiece 302 may be generated based at least in part on one or more workpiece characteristics associated with the workpiece 302 and the composite workpiece image 932. More particularly, one or more workpiece characteristics may be identified in one or more of the image segments 922 based on the composite workpiece image 932, a characteristic magnitude associated with each of the one or more workpiece characteristics may be determined based at least in part on the image segments 922, and the composite color map of the workpiece 302 may be generated based at least in part on the characteristic magnitude associated with each of the one or more workpiece characteristics.

By way of illustrative example, as shown in FIG. 11, a first workpiece characteristic 924-1 is first visible in a fourth image segment 922-4, which corresponds to a fourth radiation intensity. Plot 934-1 depicts pixel values across a cross-section of the composite workpiece image 932 that intersects with the first workpiece characteristic 924-1. Likewise, a second workpiece characteristic 924-2 is first visible in a sixth image segment 922-6, which corresponds to a sixth radiation intensity. Plot 934-2 depicts pixel values across a cross-section of the composite workpiece image 932 that intersects with the second workpiece characteristic 924-2. The characteristic magnitude of the first workpiece characteristic 924-1 and the second workpiece characteristic 924-2 may be associated with (e.g., inversely proportional to) the radiation intensity in which the workpiece characteristic first becomes visible. Put differently, the characteristic magnitude of the first workpiece characteristic 924-1 and the second workpiece characteristic 924-2 may be associated with (e.g., proportional to) the corresponding pixel value. Hence, a first characteristic magnitude associated with the first workpiece characteristic 924-1 may be greater than a second characteristic magnitude associated with the second workpiece characteristic 924-2, because the fourth radiation intensity is less than the sixth radiation intensity. Put differently the first characteristic magnitude may be greater than the second characteristic magnitude because the first workpiece characteristic 924-1 may have a greater pixel value than the second workpiece characteristic 924-2. As such, the composite color map may represent the first workpiece characteristic 924-1 in a first color or pixel value and may represent the second workpiece characteristic 924-2 in a second color or pixel value that is different from the first color or pixel value.

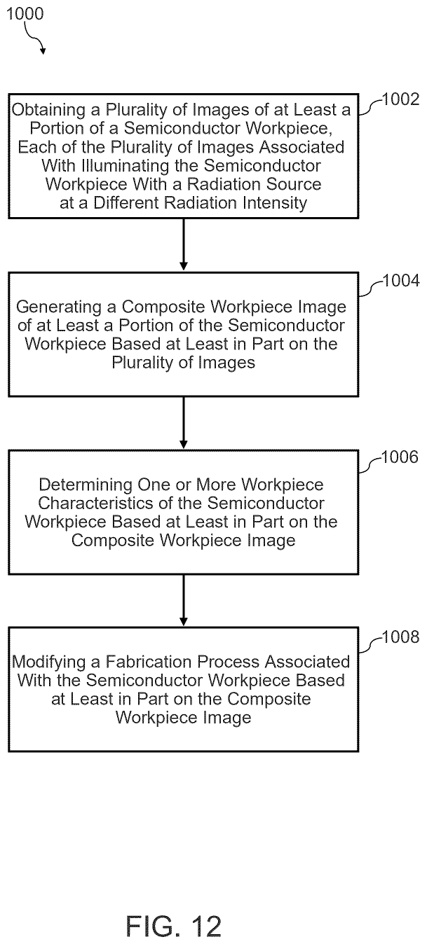

FIG. 12 depicts a flow chart diagram of an example method 1000 according to example embodiments of the present disclosure. FIG. 12 depicts example process steps for purposes of illustration and discussion. Those having ordinary skill in the art, using the disclosures provided herein, will understand that the process steps of any of the methods described in the present disclosure may be adapted, modified, include steps not illustrated, omitted, and/or rearranged without deviating from the scope of the present disclosure.

At 1002, the method 1000 includes obtaining a plurality of images of at least a portion of a semiconductor workpiece. Each of the plurality of images may be associated with illuminating the semiconductor workpiece with a radiation source at a different radiation intensity. For instance, in some examples, the radiation source may be operable to emit one or more radiation signals in a light wavelength band, which includes wavelengths in a range of about 380 nanometers to about 700 nanometers. The semiconductor workpiece may include a wide bandgap semiconductor material. For instance, in some examples, the semiconductor workpiece may be a silicon carbide (SiC) semiconductor workpiece. The semiconductor workpiece may have one or more major surfaces, and each major surface may have a surface area in a range of about 20 square centimeters (cm²) to about 800 square centimeters (cm²). Furthermore, the semiconductor workpiece may have any suitable shape, such as a circular shape and/or any suitable non-circular shape. For instance, in some examples, the semiconductor workpiece may have a diameter in a range of about 50 millimeters to about 300 millimeters, such as a diameter in a range of about 100 millimeters to about 300 millimeters, such as a diameter in a range of about 100 millimeters to about 200 millimeters.

The plurality of images may be obtained by one or more imaging devices. In some examples, the one or more imaging devices may be one or more line-scan cameras. In some examples, the one or more imaging devices may have a 12-bit color depth and may be operable to obtain the plurality of images in one or more different image modalities, such as a birefringent contrast image modality (e.g., cross-polarization image modality), a photoluminescence image modality, a reflectance based image modality, and/or the like.

In some examples, to obtain the plurality of images, each of a plurality of measurements areas of the semiconductor workpiece may be illuminated for a plurality of illumination instances, and at least one image segment of each measurement area may be obtained for each illumination instance. As described above, each illumination instance may be associated with one of a plurality of different radiation intensities associated with the radiation source that illuminates the semiconductor workpiece for the plurality of illumination instances. More particularly, the semiconductor workpiece may include a plurality of measurement areas that are defined by the plurality of illumination instances. For each measurement area of the plurality of measurement areas on the semiconductor workpiece, the measurement area may be illuminated for a plurality of illumination instances (e.g., each illumination instance being associated with one of a plurality of different radiation intensities), and a plurality of image segments associated with the measurement area may be obtained (e.g., at least one image segment being associated with each illumination instance).

In some examples, each of the plurality of images may be spatially correlated to generate a composite image segment for each measurement area. The composite image segment for each measurement area may include data associated with each measurement area for each illumination instance. In some examples, each of the plurality of images may be spatially correlated based at least in part on one or more fiducial markers. More particularly, in some examples, each of the plurality of images may include a portion of the semiconductor workpiece and at least one fiducial marker, and the at least one fiducial marker may include at least one of an ArUco pattern, an AprilTag pattern, a CALTag pattern, an ARTag pattern, and/or the like.

Additionally and/or alternatively, for each measurement area, spatial coordinates for each of the plurality of image segments associated with the measurement area may be determined, and each of the plurality of image segments may be spatially correlated based at least in part on the spatial coordinates to generate a composite image segment of the measurement area. More particularly, in some examples, scaled spatial coordinates for each of the plurality of image segments may be generated based at least in part on the spatial coordinates, an affine transformation for each of the plurality of image segments may be determined based at least in part on the scaled spatial coordinates, and the composite image segment of the measurement area may be generated based at least in part on the affine transformation of each of the plurality of image segments.

At 1004, the method 1000 includes generating a composite workpiece image of at least a portion of the semiconductor workpiece based at least in part on the plurality of images. As described above, in some examples, the composite workpiece image may be a high dynamic range (HDR) image of the semiconductor workpiece that depicts the semiconductor workpiece in one or more image modalities, such as a birefringent image modality (e.g., cross-polarization image modality), a photoluminescence image modality, and/or the like. In some examples, the composite workpiece image of at least a portion of the semiconductor workpiece may be generated based at least in part on the composite image segment associated with each measurement area.

In some examples, to generate the composite workpiece image, a response function for the plurality of images (e.g., obtained at 1002) may be determined based at least in part on one or more pixel values associated with the plurality of images. For instance, one or more pixels of each of the plurality of images may be sampled. In response to sampling the one or more pixels, one or more pixel values may be determined, and the response function may be determined based at least in part on the one or more pixel values. More particularly, a pixel value range associated with the plurality of images may be determined based at least in part on the one or more pixel values, and the pixel value range may be determined to be monotonic. In response to determining the pixel value range is monotonic, the response function for the plurality of images may be determined based at least in part on the one or more pixel values. In some examples, one or more of the plurality of images may be filtered based at least in part on the one or more pixel values.

Additionally and/or alternatively, in some examples, the response function for the plurality of images may be determined based at least in part on the plurality of image segments associated with each of the plurality of measurement areas, and the composite workpiece image of at least a portion of the semiconductor workpiece may be generated based at least in part on the response function and the plurality of image segments associated with each of the plurality of measurement areas. More particularly, in some examples, image segment data may be generated based on one or more pixel values associated with the plurality of image segments, and the response function for the plurality of images may be determined based at least in part on the image segment data and the one or more pixel values associated with the plurality of image segments. In some examples, the image segment data may include a pixel value range associated with the plurality of image segments. In some examples, the pixel value range may correspond to a bit-depth associated with an imaging device used to obtain the plurality of images (e.g., at 1002).

In some examples, a plurality of composite image segments may be generated based at least in part on the response function, each composite image segment being associated with a different measurement area of a plurality of different measurement areas of the semiconductor workpiece. Each composite image segment may include data associated with the measurement area of the plurality of measurement areas being illuminated at each of a plurality of different radiation intensities (e.g., by the radiation source). In some examples, the composite workpiece image of at least a portion of the semiconductor workpiece may be generated based at least in part on the response function and the plurality of composite image segments.

At 1006, the method 1000 optionally includes determining one or more workpiece characteristics of the semiconductor workpiece based at least in part on the composite workpiece image. For instance, in some examples, image data associated with the plurality of images and/or the composite workpiece image may be provided to a machine-learned model, and the one or more workpiece characteristics may be determined based at least in part on an output obtained from the machine-learned model. In some examples, a presence of one or more micropipes on the semiconductor workpiece may be determined based at least in part on the composite workpiece image (e.g., generated at 1004). Additionally and/or alternatively, in some examples, a presence of one or more threading edge dislocations on the semiconductor workpiece may be determined based at least in part on the composite workpiece image (e.g., generated at 1004). Additionally and/or alternatively, in some examples, a presence of one or more threading screw dislocations on the semiconductor workpiece may be determined based at least in part on the composite workpiece image (e.g., generated at 1004).

In some examples, one or more surface features associated with the semiconductor workpiece may be determined based at least in part on the composite workpiece image (e.g., generated at 1004). More particularly, in some examples, one or more defects associated with the semiconductor workpiece may be determined based at least in part on the composite workpiece image (e.g., generated at 1004). Additionally and/or alternatively, in some examples, a surface roughness of the semiconductor workpiece may be determined based at least in part on the composite workpiece image (e.g., generated at 1004). Additionally and/or alternatively, in some examples, a parallelism of the semiconductor workpiece may be determined based at least in part on the composite workpiece image (e.g., generated at 1004). Additionally and/or alternatively, in some examples, an optical wedge of the semiconductor workpiece may be determined based at least in part on the composite workpiece image (e.g., generated at 1004).

In some examples, a composite tone map of at least a portion of the semiconductor workpiece may be generated based at least in part on the composite workpiece image. The composite tone map of the semiconductor workpiece may visually depict one or more workpiece characteristics of the semiconductor workpiece in each of a plurality of different radiation intensities associated with the radiation source. For instance, the composite tone map may visually depict any of the workpiece characteristics and/or defects described herein.

At 1008, the method 1000 optionally includes modifying a fabrication process associated with the semiconductor workpiece based at least in part on the composite workpiece image. For instance, in some examples, a surface processing process associated with the semiconductor workpiece (e.g., a grinding process, a lapping process, a polishing process, etc.) may be modified based at least in part on the composite workpiece image (e.g., generated at 1004). Additionally and/or alternatively, in some examples, a crystal growth process associated with the semiconductor workpiece may be modified based at least in part on the composite workpiece image (e.g., generated at 1004). Additionally and/or alternatively, in some examples, feedback data associated with the fabrication process may be generated based at least in part on the composite workpiece image of the semiconductor workpiece (e.g., generated at 1004). The feedback data may be indicative of one or more defects associated with the fabrication process. As such, the fabrication process associated with the semiconductor workpiece may be modified based at least in part on the feedback data, such as by identifying the semiconductor workpiece for a different fabrication operation to address the one or more defects associated with the feedback data, modifying a prior fabrication operation to reduce future anomalies and/or defects, determining whether to discard the semiconductor workpiece, and/or the like.

In some examples, the method 1000 may include both operations 1006 and operation 1008. In some examples, the method may include operation 1006 without including operation 1008. For instance, the method may include determining one or more workpiece characteristics without modifying fabrication. In some examples, the method may include operation 1008 without including operation 1006. For instance, the method may include modifying fabrication without determining one or more workpiece characteristics.

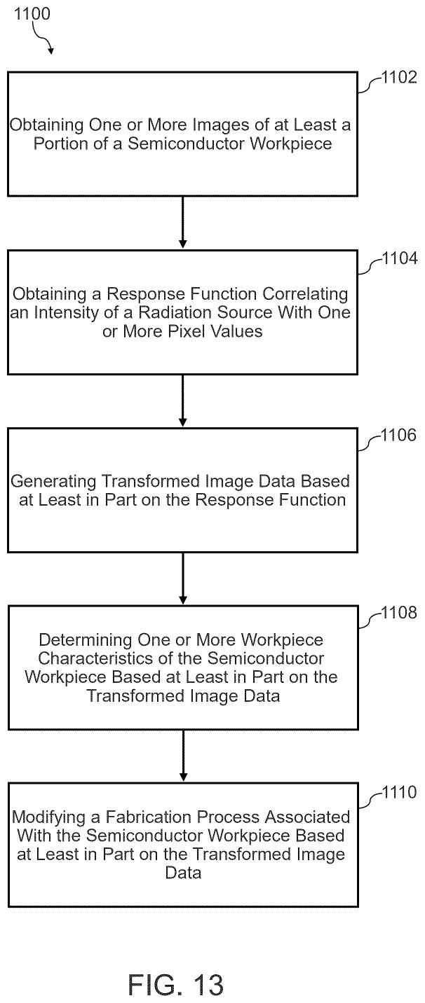

FIG. 13 depicts a flow chart diagram of an example method 1100 according to example embodiments of the present disclosure. FIG. 13 depicts example process steps for purposes of illustration and discussion. Those having ordinary skill in the art, using the disclosures provided herein, will understand that the process steps of any of the methods described in the present disclosure may be adapted, modified, include steps not illustrated, omitted, and/or rearranged without deviating from the scope of the present disclosure.

At 1102, the method 1100 includes obtaining one or more images of at least a portion of a semiconductor workpiece. For instance, in some examples, the radiation source may be operable to emit one or more radiation signals in a light wavelength band, which includes wavelengths in a range of about 380 nanometers to about 700 nanometers. The semiconductor workpiece may include a wide bandgap semiconductor material. For instance, in some examples, the semiconductor workpiece may be a silicon carbide (SiC) semiconductor workpiece. The semiconductor workpiece may have one or more major surfaces, and each major surface may have a surface area in a range of about 20 square centimeters (cm²) to about 800 square centimeters (cm²). Furthermore, the semiconductor workpiece may have any suitable shape, such as a circular shape and/or any suitable non-circular shape. For instance, in some examples, the semiconductor workpiece may have a diameter in a range of about 50 millimeters to about 300 millimeters, such as a diameter in a range of about 100 millimeters to about 300 millimeters, such as a diameter in a range of about 100 millimeters to about 200 millimeters.

The plurality of images may be obtained by one or more imaging devices. In some examples, the one or more imaging devices may be one or more line-scan cameras. In some examples, the one or more imaging devices may have a 12-bit color depth and may be operable to obtain the plurality of images in one or more different image modalities, such as a birefringent contrast image modality (e.g., cross-polarization image modality), a photoluminescence image modality, a reflectance based image modality and/or the like.

At 1104, the method 1000 includes obtaining a response function (e.g., as described herein). The response function may map pixel values of the one or more images to intensity of radiation in a physical space. The response function may be determined based at least in part on a plurality of sample images associated with exposing at least a portion of one or more semiconductor workpieces with different radiation intensities (e.g., as discussed with reference to FIG. 9 above). In some examples, obtaining the response function may include accessing a previously determined response function from memory or other storage device. In some examples, obtaining a response function may include calculating or determining the response function based at least in part on the plurality of sample images. The sample images may be previously acquired images of a semiconductor workpiece and/or may include the one or more images obtained at process operation 1102.

At 1106, the method includes generating transformed image data based at least in part on the response function. The transformed image data may include pixel values that are associated with intensities in a physical space. In some examples, the transformed image data may include composite image data as described herein.

At 1108, the method 1100 optionally includes determining one or more workpiece characteristics of the semiconductor workpiece based at least in part on the transformed image data. For instance, in some examples, the transformed image data may be provided to a machine-learned model, and the one or more workpiece characteristics may be determined based at least in part on an output obtained from the machine-learned model. In some examples, a presence of one or more micropipes on the semiconductor workpiece may be determined based at least in part on the transformed image data. Additionally and/or alternatively, in some examples, a presence of one or more threading edge dislocations on the semiconductor workpiece may be determined based at least in part on the transformed image data. Additionally and/or alternatively, in some examples, a presence of one or more threading screw dislocations on the semiconductor workpiece may be determined based at least in part on the transformed image data.

In some examples, one or more surface features associated with the semiconductor workpiece may be determined based at least in part on the transformed image data. More particularly, in some examples, one or more defects associated with the semiconductor workpiece may be determined based at least in part on the transformed image data. Additionally and/or alternatively, in some examples, a surface roughness of the semiconductor workpiece may be determined based at least in part on the transformed image data. Additionally and/or alternatively, in some examples, a parallelism of the semiconductor workpiece may be determined based at least in part on the transformed image data. Additionally and/or alternatively, in some examples, an optical wedge of the semiconductor workpiece may be determined based at least in part on the transformed image data.

At 1110, the method 1100 optionally includes modifying a fabrication process associated with the semiconductor workpiece based at least in part on the transformed image data. For instance, in some examples, a surface processing process associated with the semiconductor workpiece (e.g., a grinding process, a lapping process, a polishing process, etc.) may be modified based at least in part on the transformed image data. Additionally and/or alternatively, in some examples, a crystal growth process associated with the semiconductor workpiece may be modified based at least in part on the transformed image data. Additionally and/or alternatively, in some examples, feedback data associated with the fabrication process may be generated based at least in part on the transformed image data. The feedback data may be indicative of one or more defects associated with the fabrication process. As such, the fabrication process associated with the semiconductor workpiece may be modified based at least in part on the feedback data, such as by identifying the semiconductor workpiece for a different fabrication operation to address the one or more defects associated with the feedback data, modifying a prior fabrication operation to reduce future anomalies and/or defects, determining whether to discard the semiconductor workpiece, and/or the like.

In some examples, the method 1100 may include both operations 1108 and operation 1110. In some examples, the method may include operation 1108 without including operation 1110. For instance, the method may include determining one or more workpiece characteristics without modifying fabrication. In some examples, the method may include operation 1110 without including operation 1108. For instance, the method may include modifying fabrication without determining one or more workpiece characteristics.

Example aspects of the present disclosure are set forth below. Any of the below features or examples may be used in combination with any of the embodiments or features provided in the present disclosure.

In an aspect, the present disclosure provides an example method. In some implementations, the example method includes obtaining a plurality of images of at least a portion of a semiconductor workpiece, each of the plurality of images associated with exposing the at least a portion of the semiconductor workpiece to radiation at a different radiation intensity. In some implementations, the example method includes generating a composite workpiece image of at least a portion of the semiconductor workpiece based at least in part on the plurality of images.

In some implementations of the example method, the composite workpiece image is a high dynamic range (HDR) image of the semiconductor workpiece.

In some implementations of the example method, the plurality of images are associated with a birefringent contrast image modality.

In some implementations of the example method, the plurality of images are associated with a photoluminescence image modality.

In some implementations of the example method, obtaining the plurality of images of at least a portion of the semiconductor workpiece includes illuminating the at least a portion of the semiconductor workpiece with a radiation source having a non-uniform radiation distribution.

In some implementations of the example method, the plurality of images are captured with a same exposure time.

In some implementations of the example method, each of the plurality of images is associated with a line scan.

In some implementations of the example method, generating the composite workpiece image of at least a portion of the semiconductor workpiece includes obtaining a response function for the plurality of images. In some implementations of the example method, generating the composite workpiece image of at least a portion of the semiconductor workpiece includes generating the composite image based at least in part on the response function. In some implementations of the example method, generating the composite workpiece image of at least a portion of the semiconductor workpiece includes wherein the response function is determined based at least in part on one or more pixel values associated with the plurality images, the plurality of images each associated with exposing the at least a portion of the workpiece to a different radiation intensity.

In some implementations of the example method, obtaining the response function includes accessing a previously determined response function stored in a memory device.

In some implementations of the example method, obtaining the response function includes calculating a response function.

In some implementations of the example method, the response function maps pixel values of the plurality of images to intensity of radiation in a physical space.

In some implementations of the example method, obtaining the response function for the plurality of images includes sampling one or more pixels of each of the plurality of images. In some implementations of the example method, obtaining the response function for the plurality of images includes in response to sampling the one or more pixels, determining the one or more pixel values. In some implementations of the example method, obtaining the response function for the plurality of images includes determining the response function based at least in part on the one or more pixel values.

In some implementations, the example method includes filtering one or more of the plurality of images based at least in part on the one or more pixel values.

In some implementations of the example method, obtaining the response function includes determining a pixel value range associated with the plurality of images based at least in part on the one or more pixel values. In some implementations of the example method, obtaining the response function includes determining the pixel value range is monotonic. In some implementations of the example method, obtaining the response function includes in response to determining the pixel value range is monotonic, determining the response function for the plurality of images based at least in part on the one or more pixel values.

In some implementations of the example method, generating the composite workpiece image includes spatially coordinating the plurality of images.

In some implementations of the example method, spatially correlating the plurality of images includes generating scaled spatial coordinates for each of the plurality of images. In some implementations of the example method, spatially correlating the plurality of images includes determining an affine transformation for each of the plurality of images based at least in part on the scaled spatial coordinates.

In some implementations, the example method includes determining one or more workpiece characteristics of the semiconductor workpiece based at least in part on the composite workpiece image.

In some implementations of the example method, determining the one or more workpiece characteristics of the semiconductor workpiece includes providing image data associated with the composite workpiece image to a machine-learned model. In some implementations of the example method, determining the one or more workpiece characteristics of the semiconductor workpiece includes determining the one or more workpiece characteristics for the semiconductor workpiece based at least in part on an output obtained from the machine-learned model.

In some implementations of the example method, determining the one or more workpiece characteristics of the semiconductor workpiece includes determining a presence of one or more micropipes, threading dislocations, or threading screw dislocations on the semiconductor workpiece based at least in part on the composite workpiece image.

In some implementations of the example method, the one or more workpiece characteristics comprise at least one of one or more defects associated with the semiconductor workpiece. In some implementations of the example method, the one or more workpiece characteristics comprise at least one of a surface roughness of the semiconductor workpiece. In some implementations of the example method, the one or more workpiece characteristics comprise at least one of a parallelism of the semiconductor workpiece. In some implementations of the example method, the one or more workpiece characteristics comprise at least one of an optical wedge of the semiconductor workpiece.

In some implementations, the example method includes modifying a fabrication process associated with the semiconductor workpiece based at least in part on the composite workpiece image.

In some implementations of the example method, modifying the fabrication process associated with the semiconductor workpiece includes generating feedback data associated with the fabrication process based at least in part on the composite workpiece image of the semiconductor workpiece, the feedback data being indicative of one or more defects associated with the fabrication process. In some implementations of the example method, modifying the fabrication process associated with the semiconductor workpiece includes modifying the fabrication process associated with the semiconductor workpiece based at least in part on the feedback data.

In some implementations of the example method, modifying the fabrication process associated with the semiconductor workpiece includes identifying the semiconductor workpiece for a different fabrication operation to address the one or more defects associated with the feedback data.

In some implementations of the example method, modifying the fabrication process associated with the semiconductor workpiece includes modifying a surface processing process associated with the semiconductor workpiece, the surface processing process comprising one or more of a grinding process, a lapping process, or a polishing process.

In some implementations of the example method, modifying the fabrication process associated with the semiconductor workpiece includes modifying a crystal growth process associated with the semiconductor workpiece.

In some implementations of the example method, modifying the fabrication process associated with the semiconductor workpiece includes determining whether to discard the semiconductor workpiece.

In some implementations of the example method, the composite workpiece image includes data associated with each of a plurality of different radiation intensities for the at least a portion of the workpiece.

In some implementations of the example method, the semiconductor workpiece is a silicon carbide (SiC) semiconductor workpiece.

In an aspect, the present disclosure provides an example semiconductor workpiece inspection system. In some implementations, the example semiconductor workpiece inspection system includes an imaging device. In some implementations, the example semiconductor workpiece inspection system includes a radiation source. In some implementations, the example semiconductor workpiece inspection system includes a workpiece holder operable to receive a semiconductor workpiece. In some implementations, the example semiconductor workpiece inspection system includes control circuitry operable to perform operations. In some implementations, the operations include obtaining a plurality of images of at least a portion of a semiconductor workpiece, each of the plurality of images associated with exposing the at least a portion of the semiconductor workpiece to radiation at a different radiation intensity. In some implementations, the operations include generating a composite workpiece image of at least a portion of the semiconductor workpiece based at least in part on the plurality of images.

In some implementations of the example semiconductor workpiece inspection system, the composite workpiece image is a high dynamic range (HDR) image of the semiconductor workpiece.

In some implementations of the example semiconductor workpiece inspection system, the plurality of images are associated with a birefringent contrast image modality.

In some implementations of the example semiconductor workpiece inspection system, the plurality of images are associated with a photoluminescence image modality.

In some implementations of the example semiconductor workpiece inspection system, obtaining the plurality of images of at least a portion of the semiconductor workpiece includes illuminating the at least a portion of the semiconductor workpiece with a radiation source having a non-uniform radiation distribution.

In some implementations of the example semiconductor workpiece inspection system, the plurality of images are captured with a same exposure time.

In some implementations of the example semiconductor workpiece inspection system, each of the plurality of images is associated with a line scan.

In some implementations of the example semiconductor workpiece inspection system, generating the composite workpiece image of at least a portion of the semiconductor workpiece includes obtaining a response function for the plurality of images. In some implementations of the example semiconductor workpiece inspection system, generating the composite workpiece image of at least a portion of the semiconductor workpiece includes generating the composite image based at least in part on the response function. In some implementations of the example semiconductor workpiece inspection system, the response function is determined based at least in part on one or more pixel values associated with the plurality images. The plurality of images each associated with exposing the at least a portion of the workpiece to a different radiation intensity.

In some implementations of the example semiconductor workpiece inspection system, obtaining the response function includes accessing a previously determined response function stored in a memory device.

In some implementations of the example semiconductor workpiece inspection system, obtaining the response function includes calculating a response function.

In some implementations of the example semiconductor workpiece inspection system, the response function maps pixel values of the plurality of images to intensity of radiation in a physical space.

In some implementations of the example semiconductor workpiece inspection system, obtaining the response function for the plurality of images includes sampling one or more pixels of each of the plurality of images. In some implementations of the example semiconductor workpiece inspection system, obtaining the response function for the plurality of images includes in response to sampling the one or more pixels, determining the one or more pixel values. In some implementations of the example semiconductor workpiece inspection system, obtaining the response function for the plurality of images includes determining the response function based at least in part on the one or more pixel values.

In some implementations of the example semiconductor workpiece inspection system, the operations further comprise filtering one or more of the plurality of images based at least in part on the one or more pixel values.

In some implementations of the example semiconductor workpiece inspection system, obtaining the response function includes determining a pixel value range associated with the plurality of images based at least in part on the one or more pixel values. In some implementations of the example semiconductor workpiece inspection system, obtaining the response function includes determining the pixel value range is monotonic. In some implementations of the example semiconductor workpiece inspection system, obtaining the response function includes in response to determining the pixel value range is monotonic, determining the response function for the plurality of images based at least in part on the one or more pixel values.

In some implementations of the example semiconductor workpiece inspection system, generating the composite workpiece image includes spatially coordinating the plurality of images.

In some implementations of the example semiconductor workpiece inspection system, spatially correlating the plurality of images includes generating scaled spatial coordinates for each of the plurality of images. In some implementations of the example semiconductor workpiece inspection system, spatially correlating the plurality of images includes determining an affine transformation for each of the plurality of images based at least in part on the scaled spatial coordinates.

In some implementations, the example semiconductor workpiece inspection system includes determining one or more workpiece characteristics of the semiconductor workpiece based at least in part on the composite workpiece image.

In some implementations of the example semiconductor workpiece inspection system, determining the one or more workpiece characteristics of the semiconductor workpiece includes providing image data associated with the composite workpiece image to a machine-learned model. In some implementations of the example semiconductor workpiece inspection system, determining the one or more workpiece characteristics of the semiconductor workpiece includes determining the one or more workpiece characteristics for the semiconductor workpiece based at least in part on an output obtained from the machine-learned model.

In some implementations of the example semiconductor workpiece inspection system, the composite workpiece image includes data associated with each of a plurality of different radiation intensities for the at least a portion of the workpiece.

In some implementations of the example semiconductor workpiece inspection system, the radiation source is configured to provide radiation in a non-uniform radiation distribution.

In some implementations of the example semiconductor workpiece inspection system, the semiconductor workpiece is a silicon carbide (SiC) semiconductor workpiece.

In an aspect, the present disclosure provides an example method. In some implementations, the example method includes obtaining one or more images of at least a portion of a semiconductor workpiece. In some implementations, the example method includes obtaining a response function correlating an intensity of a radiation source with pixel values, wherein the response function is determined based at least in part on a plurality of sample images associated with exposing at least a portion of one or more semiconductor workpieces with different radiation intensities. In some implementations, the example method includes generating transformed image data based at least in part on the response function.

In some implementations, the example method includes sampling one or more pixels of each of the plurality of sample images. In some implementations, the example method includes in response to sampling the one or more pixels, determining the one or more pixel values. In some implementations, the example method includes determining the response function based at least in part on the one or more pixel values.

In some implementations, the example method includes determining a pixel value range associated with the plurality of sample images based at least in part on the one or more pixel values. In some implementations, the example method includes determining the pixel value range is monotonic. In some implementations, the example method includes in response to determining the pixel value range is monotonic, determining the response function based at least in part on the one or more pixel values.

In some implementations of the example method, the response function maps pixel values of the one or more images to intensity of radiation in a physical space.

In some implementations of the example method, the method includes determining one or more workpiece characteristics of the semiconductor workpiece based at least in part on transformed image data.

In some implementations of the example method, the method includes modifying semiconductor fabrication based at least in part on transformed image data.

In some implementations of the example method, the one or more images are associated with a birefringent contrast image modality.

In some implementations of the example method, the one or more images are associated with a photoluminescence image modality.

In some implementations of the example method, the semiconductor workpiece includes silicon carbide.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method, comprising:
obtaining a plurality of images of at least a portion of a semiconductor workpiece, each of the plurality of images associated with exposing the at least a portion of the semiconductor workpiece to radiation at a different radiation intensity; and
generating a composite workpiece image of at least a portion of the semiconductor workpiece based at least in part on the plurality of images.

2. The method of claim 1, wherein the composite workpiece image is a high dynamic range (HDR) image of the semiconductor workpiece.

3. The method of claim 1, wherein the plurality of images are associated with one of a birefringent contrast image modality or a photoluminescence image modality.

4. The method of claim 1, wherein obtaining the plurality of images of at least a portion of the semiconductor workpiece comprises illuminating the at least a portion of the semiconductor workpiece with a radiation source having a non-uniform radiation distribution.

5. The method of claim 1, wherein the plurality of images are captured with a same exposure time.

6. The method of claim 1, wherein generating the composite workpiece image of at least a portion of the semiconductor workpiece comprises:
obtaining a response function for the plurality of images; and
generating the composite image based at least in part on the response function;
wherein the response function is determined based at least in part on one or more pixel values associated with the plurality images, the plurality of images each associated with exposing the at least a portion of the workpiece to a different radiation intensity.

7. The method of claim 6, wherein obtaining the response function for the plurality of images comprises:
sampling one or more pixels of each of the plurality of images;
in response to sampling the one or more pixels, determining the one or more pixel values; and
determining the response function based at least in part on the one or more pixel values.

8. The method of claim 6, wherein the response function maps pixel values of the plurality of images to intensity of radiation in a physical space.

9. The method of claim 8, wherein obtaining the response function comprises:
determining a pixel value range associated with the plurality of images based at least in part on the one or more pixel values;
determining the pixel value range is monotonic; and
in response to determining the pixel value range is monotonic, determining the response function for the plurality of images based at least in part on the one or more pixel values.

10. The method of claim 1, wherein generating the composite workpiece image comprises spatially coordinating the plurality of images.

11. The method of claim 10, wherein spatially correlating the plurality of images comprises:
generating scaled spatial coordinates for each of the plurality of images;
determining an affine transformation for each of the plurality of images based at least in part on the scaled spatial coordinates.

12. The method of claim 1, further comprising:
determining one or more workpiece characteristics of the semiconductor workpiece based at least in part on the composite workpiece image.

13. The method of claim 12, wherein determining the one or more workpiece characteristics of the semiconductor workpiece comprises:
providing image data associated with the composite workpiece image to a machine-learned model; and
determining the one or more workpiece characteristics for the semiconductor workpiece based at least in part on an output obtained from the machine-learned model.

14. The method of claim 12, wherein determining the one or more workpiece characteristics of the semiconductor workpiece comprises determining a presence of one or more micropipes, threading dislocations, or threading screw dislocations on the semiconductor workpiece based at least in part on the composite workpiece image.

15. The method of claim 12, wherein the one or more workpiece characteristics comprise at least one of:
one or more defects associated with the semiconductor workpiece;
a surface roughness of the semiconductor workpiece;
a parallelism of the semiconductor workpiece; or
an optical wedge of the semiconductor workpiece.

16. The method of claim 1, further comprising:
modifying a fabrication process associated with the semiconductor workpiece based at least in part on the composite workpiece image.

17. The method of claim 16, wherein modifying the fabrication process associated with the semiconductor workpiece comprises:
generating feedback data associated with the fabrication process based at least in part on the composite workpiece image of the semiconductor workpiece, the feedback data being indicative of one or more defects associated with the fabrication process; and
modifying the fabrication process associated with the semiconductor workpiece based at least in part on the feedback data.

18. The method of claim 1, wherein the composite workpiece image comprises data associated with each of a plurality of different radiation intensities for the at least a portion of the workpiece.

19. A semiconductor workpiece inspection system, comprising:
an imaging device;
a radiation source;
a workpiece holder operable to receive a semiconductor workpiece; and
control circuitry operable to perform operations, comprising:
obtaining a plurality of images of at least a portion of a semiconductor workpiece, each of the plurality of images associated with exposing the at least a portion of the semiconductor workpiece to radiation at a different radiation intensity; and
generating a composite workpiece image of at least a portion of the semiconductor workpiece based at least in part on the plurality of images.

20. A method for inspecting a semiconductor workpiece, comprising:
obtaining one or more images of at least a portion of a semiconductor workpiece;
obtaining a response function correlating an intensity of a radiation source with pixel values, wherein the response function is determined based at least in part on a plurality of sample images associated with exposing at least a portion of one or more semiconductor workpieces with different radiation intensities; and
generating transformed image data based at least in part on the response function.
